(19) United States
(12) Patent Application Publication
(10) Pub. No.: US 2015/0092023 A1
(43) Pub. Date: Apr. 2, 2015

(54) IMAGE PICKUP APPARATUS AND IMAGE PICKUP METHOD

(71) Applicant: OLYMPUS CORPORATION, Tokyo (JP)

(72) Inventor: Ayako ASAKURA, Hino-shi (JP)

(73) Assignee: OLYMPUS CORPORATION, Tokyo (JP)

(21) Appl. No.: 14/567,866

(22) Filed: Dec. 11, 2014

Related U.S. Application Data
(63) Continuation of application No. PCT/JP2013/069855, filed on Jul. 23, 2013.

(30) Foreign Application Priority Data
Jul. 30, 2012 (JP) 2012168241
Jul. 30, 2012 (JP) 2012168242

(51) Int. Cl. H04N 13/00; H04N 13/02; H04N 5/232; G03B 13/36

(52) U.S. Cl. CPC H04N 13/0018; G03B 13/36; H04N 13/0221; H04N 5/23212; H04N 5/23296
USPC 348/49

(57) ABSTRACT

An image pickup apparatus having not less than three optical systems, and an image pickup element which picks up an object image by the optical system, includes an object-information acquiring section which acquires information of an object, a parallax-amount computing section which computes an amount of parallax corresponding to the information of the object, and an optical-system selecting section which selects optical systems for photographing from among not less than three optical systems, based on the amount of parallax corresponding to the information of the object, that has been computed by the parallax-amount computing section.

### CROSS-REFERENCE TO RELATED APPLICATION

The present application is a continuation application of PCT/JP2013/069855 filed on Jul. 23, 2013 and claims a benefit of priority from the prior Japanese Patent Application Nos. 2012-168241 filed on Jul. 30, 2012 and 2012-168242 filed on Jul. 30, 2012; the entire contents of which are incorporated herein by reference.

### BACKGROUND OF THE INVENTION

1. Field of the Invention

The present invention relates to an image pickup apparatus and an image pickup method.

2. Description of the Related Art

At the time of displaying a stereoscopic image, if an object is not displayed with an appropriate parallax, it has been known that the display becomes unnatural. Moreover, a main procedure for correcting parallax in a case of photographing by a parallel method, is adjusting a distance from a camera at the time of photographing, or correcting coordinates of an image after photographing.

For example, in Japanese Patent Application Laid-open Publication No. 2002-232913, the parallax is adjusted by moving a distance from the camera, or in other words, a base length in parallel, in accordance with an optimum amount of parallax of an individual from a distance of a focusing position. Moreover, when there is a difference between the optimum parallax and the practical parallax, an image is displayed upon shifting by an amount equivalent to the difference.

This will be explained more specifically by using FIG. 25A, FIG. 25B, FIG. 25C, FIG. 25D, FIG. 26A, FIG. 26B, and FIG. 26C. In FIG. 25A, by using an optical system OPA and an optical system OPB, objects 1a, 1b, 1c, 1d, and 1e are photographed by using the parallel method.

FIG. 25B shows a photographic image by the optical system OPA. FIG. 25C shows a photographic image by the optical system OPB. FIG. 25D shows a photographing range overlapping between the optical system OPA and the optical system OPB.

FIG. 26A, FIG. 26B, and FIG. 26C are diagrams describing coordinate conversion in the parallel method. FIG. 26A shows a state before correction. FIG. 26B shows a state after correction. FIG. 26C shows a state of a display image. Images on left and right not being photographed accurately, it is not possible to achieve an appropriate stereoscopic image.

Moreover, in Japanese Patent Application Laid-open Publication No. 2012-054862, adjusting according to the following two procedures in order that a difference in the parallax of continuous data is within a threshold range, has been proposed.
(1) To shift images on the left and right in a horizontal direction only by a correction amount.
(2) To correct the parallax by changing an amount of shift according to a position and a distance of an object for each object.

### SUMMARY OF THE INVENTION

To solve the abovementioned issues and to achieve an object, an image pickup apparatus according to the present invention having not less than three optical systems, and an image pickup element which picks up an object image by the optical system, includes

an object-information acquiring section which acquires information of an object,

a parallax-amount computing section which computes an amount of parallax corresponding to the information of the object, and

an optical-system selecting section which selects an optical system for photographing from among not less than three optical systems, based on the amount of parallax corresponding to the information of the object, that has been computed by the parallax-amount computing section.

Moreover, an image pickup method according to the present invention includes

an object-information acquiring step of acquiring information of an object,

a parallax-amount computing step of computing an amount of parallax corresponding to the information of the object, and

an optical-system selecting step of selecting an optical system for photographing from among not less than three optical systems, based on the amount of parallax corresponding to the information of the object, that has been computed.

Moreover, an image pickup apparatus according to another aspect of the present invention having not less than two optical systems having different focal lengths, and an image pickup element which picks up an object image by the optical system, includes

an object-information acquiring section which acquires information of an object,

a parallax-amount computing section which computes an amount of parallax corresponding to the information of the object, and

a parallax correcting section which corrects the amount of parallax.

Moreover, an image pickup method according to another aspect of the present invention includes

an object-information acquiring step of acquiring information of an object,

a parallax-amount computing step of computing an amount of parallax corresponding to the information of the object, and

a parallax correcting step of correcting the amount of parallax, based on information from two or more than two optical systems having different focal lengths.

### BRIEF DESCRIPTION OF THE DRAWINGS

FIG. 1 is a diagram showing functional blocks of an image pickup apparatus according to a first embodiment of the present invention;

FIG. 2A is a front view when the image pickup apparatus is applied to a portable terminal, FIG. 2B is a rear view of the portable terminal, and FIG. 2C is a side view of the portable terminal;

FIG. 3 is a diagram showing functional blocks of the image pickup apparatus according to the first embodiment;

FIG. 4A, FIG. 4B, FIG. 4C, FIG. 4D, FIG. 4E, and FIG. 4F are diagrams showing an arrangement of a plurality of optical systems in the image pickup apparatus according to the first embodiment;

FIG. 5A, FIG. 5B, FIG. 5C, FIG. 5D, FIG. 5E, and FIG. 5F are diagrams showing an arrangement of positions of optical axes of the plurality of optical systems in the image pickup apparatus according to the first embodiment;

FIG. 6A and FIG. 6B are diagrams showing examples of photographing range;

FIG. 7A, FIG. 7B, and FIG. 7C are diagrams explaining a plurality of objects;

FIG. 8 is another diagram explaining the plurality of objects;

FIG. 9 is still another diagram explaining the plurality of objects;

FIG. 10 is a diagram explaining parameters;

FIG. 11 is a flowchart showing a procedure of an image pickup method according to a second embodiment of the present invention;

FIG. 12 is another flowchart showing a procedure of the image pickup method according to the second embodiment;

FIG. 13 is still another flowchart showing a procedure of the image pickup method according to the second embodiment;

FIG. 14 is a diagram showing functional blocks of an image pickup apparatus according to a third embodiment of the present invention;

FIG. 15 is a diagram showing functional blocks of the image pickup apparatus according to the third embodiment;

FIG. 16A, FIG. 16B, FIG. 16C, FIG. 16D, FIG. 16E, and FIG. 16F are diagrams showing an arrangement of a plurality of optical systems in the image pickup apparatus according to the third embodiment;

FIG. 17A, FIG. 17B, and FIG. 17C are diagrams showing an arrangement of positions of optical axes of the plurality of optical systems in the image pickup apparatus according to the third embodiment;

FIG. 18A, FIG. 18B, and FIG. 18C are diagrams explaining rotation of the optical systems;

FIG. 19 is a flowchart showing a procedure of an image pickup method according to a fourth embodiment of the present invention;

FIG. 20 is another flowchart showing a procedure of the image pickup method according to the fourth embodiment;

FIG. 21 is still another flowchart showing a procedure of the image pickup method according to the fourth embodiment;

FIG. 22A, FIG. 22B, FIG. 22C, and FIG. 22D are diagrams showing division of an image pickup surface of an image pickup element;

FIG. 23 is a front perspective view showing an appearance of a digital camera according to the embodiment;

FIG. 24A is a front view of an arrangement in which, fixed-focus optical systems are arranged side-by-side, and FIG. 24B is a front view of an arrangement in which, zooming optical systems are arranged;

FIG. 25A, FIG. 25B, FIG. 25C, and FIG. 25D are diagrams explaining photographic images by a plurality of optical systems; and

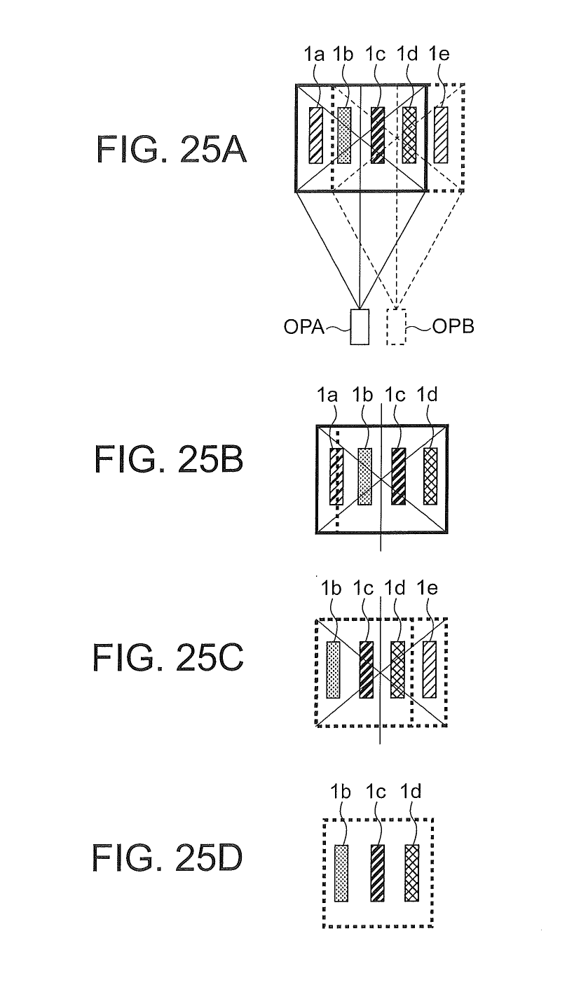

FIG. 26A, FIG. 26B, and FIG. 26C are other diagrams explaining photographic images by the plurality of optical systems.

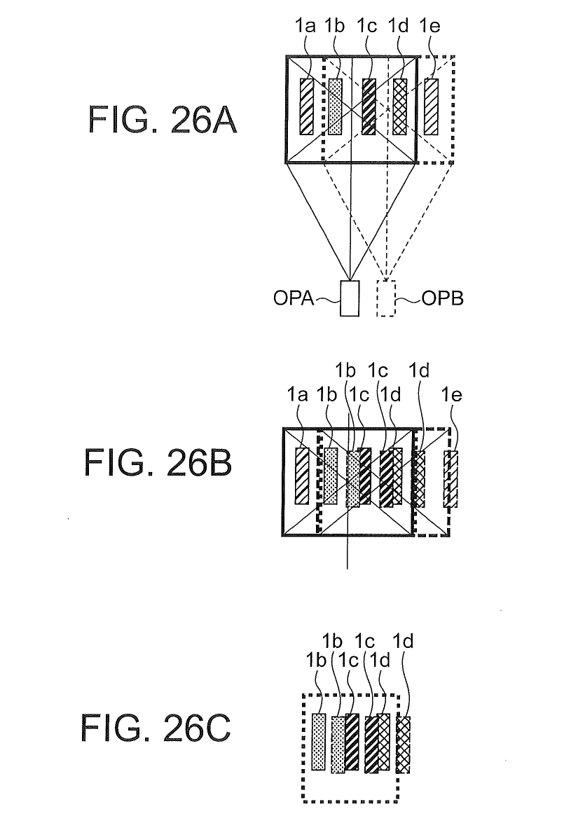

### DETAILED DESCRIPTION OF THE INVENTION

An action and effect of an image pickup apparatus and an image pickup method according to exemplary embodiments of the present invention will be described below. However, the present invention is not restricted to the embodiments described below. In other words, in the description of the embodiments, a large number of specific contents in detail are included for exemplification. However, even addition of various modifications and variations in these contents in detail will be within the scope of the present invention. Consequently, the exemplified embodiments of the present invention described below have been mentioned without loss of generality of the invention claimed, and moreover, without restricting in any way the invention claimed.

### First Embodiment

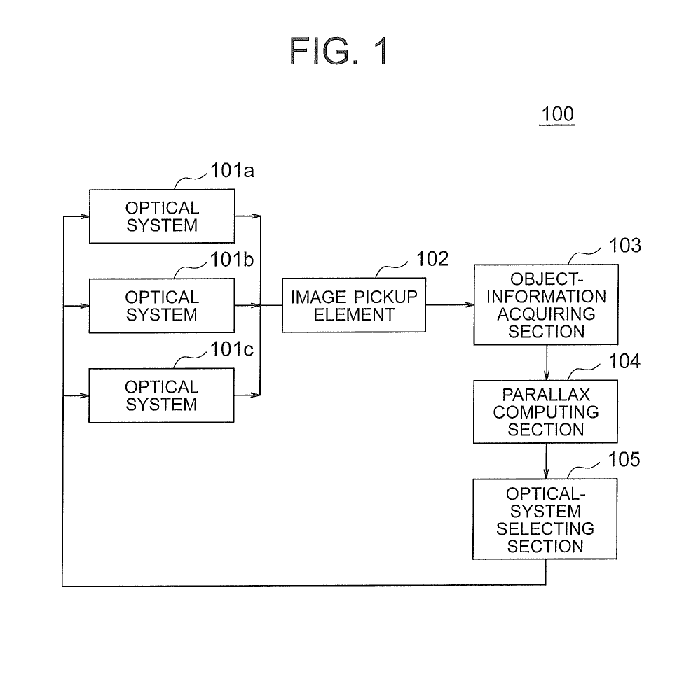

FIG. 1 is a basic functional block diagram of an image pickup apparatus 100 according to a first embodiment of the present invention.

The image pickup apparatus 100 includes three optical systems 101a, 101b, and 101c, or more, and an image pickup element 102 which picks up an object image by the optical system. Furthermore, the image pickup apparatus 100 includes an object-information acquiring section 103, a parallax-amount computing section 104, and an optical-system selecting section 105.

The object-information acquiring section 103 acquires information of an object. The parallax-amount computing section 104 computes an amount of parallax corresponding to the information of the object. The optical-system selecting section 105 selects optical systems for photographing from among the optical systems 101a, 101b, and 101c, or more, based on the amount of parallax corresponding to the information of the object, which has been computed by the parallax-amount computing section 104.

Accordingly, the image pickup apparatus 100 according to the first embodiment is capable of acquiring an image with an appropriate amount of parallax without moving the optical systems. Here, the ‘appropriate amount of parallax’ refers to an amount of parallax that enables to achieve a stereoscopic effect easily. The amount of parallax that enables to achieve the stereoscopic effect easily can be defined in advance as based on guidelines of 3-D (three-dimensional) consortium, or experimentally, or based on simulation etc.

Moreover, the optical systems are to be selected to get closer to the appropriate amount of parallax that has been defined. The definition of the ‘appropriate amount of parallax’ is similar in the following description. The amount of parallax which the parallax-amount computing section 104 computes is determined from photographing conditions and observation conditions. Selection of the photographing conditions and the observation conditions may be carried out automatically or manually.

For instance, as a photographing condition, it is possible to select photographing by a multi-function cellular telephone (hereinafter, called as ‘smart phone’), and as an observation condition, it is possible to select observing by a smart phone or observing by another display.

Here, the amount of parallax may be computed for one of an object at a nearest position and an object at a farthest position with reference to a focusing distance (distance from an image pickup position up to a focal position), from the information of the object that has been acquired.

Furthermore, the parallax-amount computing section 104 is also capable of computing the amount of parallax by using a parallax map (parallax table) in which, observation conditions possessed in advance are reflected. In this case, the image pickup apparatus 100 may be equipped with a memory which is not shown in the diagram, and the memory may have the parallax map recorded therein.

The image pickup element 102 may have an arrangement of one-to-one in which, one image pickup element is provided for one optical system, or an arrangement in which, one image pickup element is provided for a plurality of optical systems.

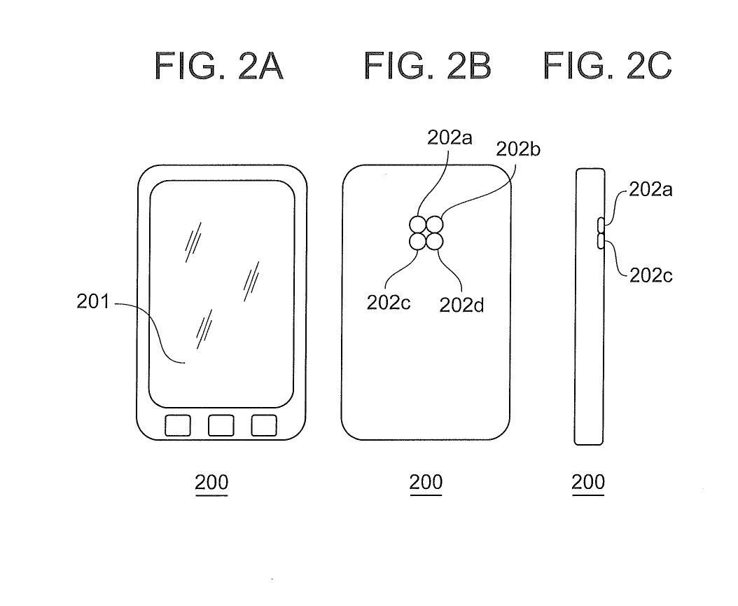

FIG. 2A is a front view of a portable terminal 200 which is an example of the image pickup apparatus 100, FIG. 2B is a rear view of the portable terminal 200, and FIG. 2C is a side view of the portable terminal 200.

In FIG. 2A, a display section 201 displays an image that has been picked up by an optical system which will be described later. In FIG. 2B, the portable terminal 200 has a plurality of optical systems having different focal lengths, and in this example, the portable terminal 200 has four optical systems 202a, 202b, 202c, and 202d. However, the number of optical systems is not restricted to four. The portable terminal may be a portable information processing apparatus such as a cellular telephone, a PHS, a smart phone, and a PDA (personal digital assistance).

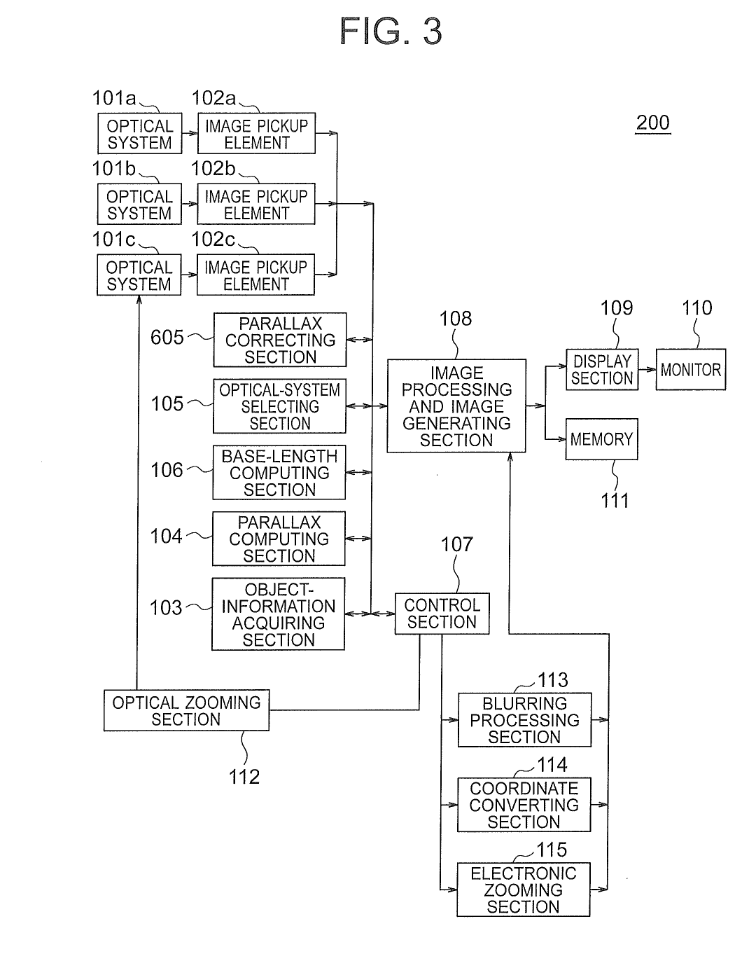

Next, the arrangement will be described in detail by using FIG. 3. Here, FIG. 1 shows an indispensable arrangement of the first embodiment, and FIG. 3 shows a more desirable arrangement.

The three optical systems 101a, 101b, and 101c or more are arranged such that distance between optical axes of optical systems differs.

The portable terminal 200, in addition to the mage pickup apparatus 100, includes a base-length computing section 106, a control section 107, an image processing and image generating section 108, a display section 109, a monitor 110, a memory 111, an optical zooming section 112, a blurring processing section 113, a coordinate converting section 114, and an electronic zooming section 115. In FIG. 3, the image pickup element 102 includes image pickup elements 102a, 102b, and 102c. However, the image pickup element 102 may include one image pickup element.

A parallax correcting section 605 corrects an amount of parallax based on information from the optical system for photographing selected from the two or more than two optical systems 101a and 101b. A detailed procedure for correcting the amount of parallax will be described later. The object-information acquiring section 103 acquires information of an object. The parallax-amount computing section 104 computes a range of the appropriate amount of parallax from a position of the object. Moreover, the base-length computing section 106 computes a base length at which the appropriate amount of parallax is achieved, based on the information of the object obtained from the object-information acquiring section 103 and the range of the amount of parallax that has been computed by the parallax-amount computing section 104. The optical-system selecting section 105 selects an optical system having a distance between the optical axes nearest to the base length that has been computed.

The image processing and image generating section 108 generates an image which is subjected to blurring processing and coordinate conversion that will be described later. The memory 111 stores image data generated by the image processing and image generating section 108. The display section 109 displays the image generated by the image processing and image generating section 108. The monitor 110 displays the image generated by the image processing and image generating section 108.

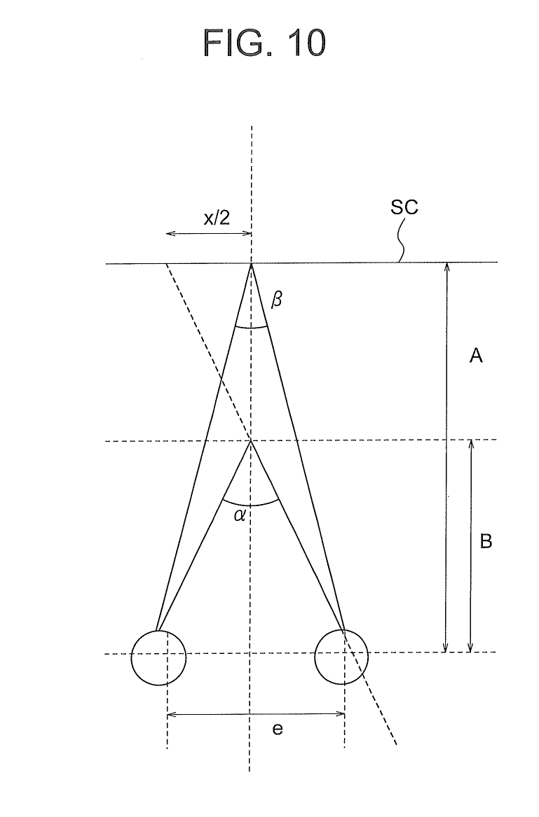

A method of calculating the base length based on the object distance and the parallax will be described by referring to FIG. 10. Here, the object distance refers to a distance from the image pickup apparatus 100 up to the object.

For computing the appropriate amount of parallax at the time of observation, a pop-out appropriate maximum parallax amount x is expressed by the following expression (1). Here, the pop-out appropriate maximum parallax amount refers to an appropriate parallax for an object that an observer is able to observe as if popping out nearest toward the observer. In FIG. 10, the observer, at a position away by B from an eye of the observer, is able to observe as if the object is popped out nearest toward the observer.

x=(A−B)×e/B (1)

where,

e denotes a width of the eye of the observer,

A denotes an observation distance (distance from the eye of the observer up to a screen SC), and

B denotes an appropriate shortest display distance (a distance from the eye of the observer up to a position that is seen to be popped out nearest for the observer)

Abase length D is expressed by the following expression

D=X/LA×LB/M (1a)

M=F/(LA−F)

where,

LA denotes a parallax 0 distance (a position from the image pickup apparatus 100 up to the object that the observer is able to observe up to a position of the screen SC)

LB denotes the object distance (distance from the image pickup apparatus 100 up to the object),

F denotes a focal length of a lens forming the optical system, and

X denotes the pop-out appropriate maximum parallax amount on the image pickup element (=x×size of display monitor/size of image pickup element).

### (Example of Calculation of Base Length)

In a case of observing an object using a 4.3 inch smart phone (HD (high definition) display), the observation distance is let to be 250 mm and the width of eyes is let to be 65 mm. A position of the shortest stereoscopic image that can be observed appropriately is at 234 mm from the eyes of the observer, and the amount of parallax at that time becomes 4.44 mm.

Whereas, in a case of photographing by using a camera of a smart phone, when the number of pixels is HD and a pixel pitch is 2 μm for instance, the amount of parallax becomes 0.18 mm on the image pickup element.

The base length when the focusing distance is let to be 1000 mm and the shortest object distance is let to be 800 mm, becomes 5.6 mm

In a case in which, distance between optical axes of the optical systems selected is 5 mm, a difference between the optimum parallax and a practical parallax is 0.16 mm. Correction of parallax is carried out by shifting an image by that amount.

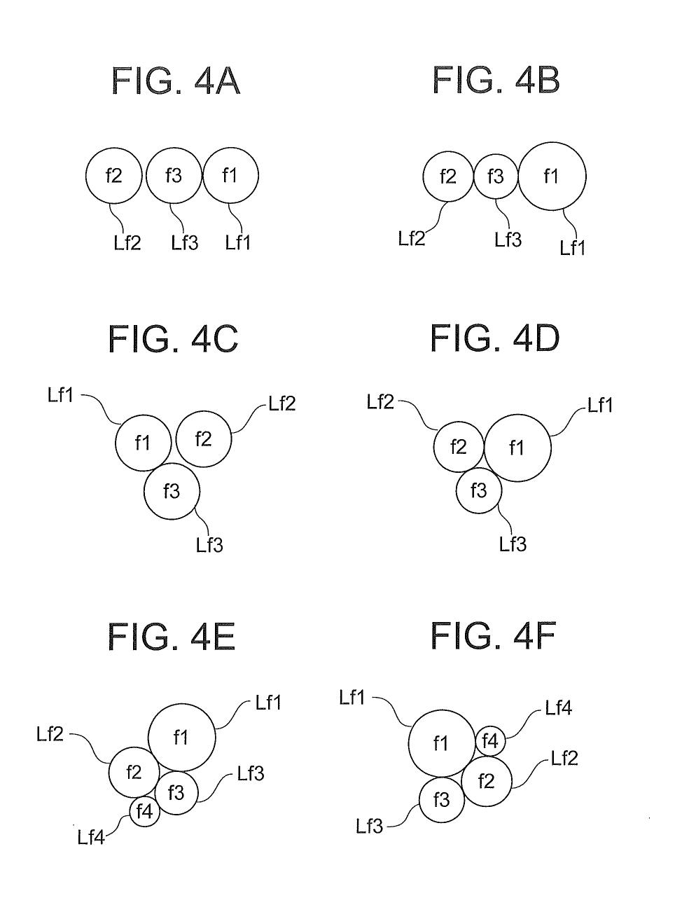

Here, a variation in arrangement of the plurality of optical system will be described below. FIG. 4A, FIG. 4B, FIG. 4C, FIG. 4D, FIG. 4E, and FIG. 4F are diagrams when an arrangement of three or four optical systems Lf1, Lf2, Lf3, and Lf4 is seen from a front.

In the diagrams, to make it easily understandable, a diameter of a circular-shaped lens is shown to be large with the focal length becoming short (becomes a wide-angle optical system).

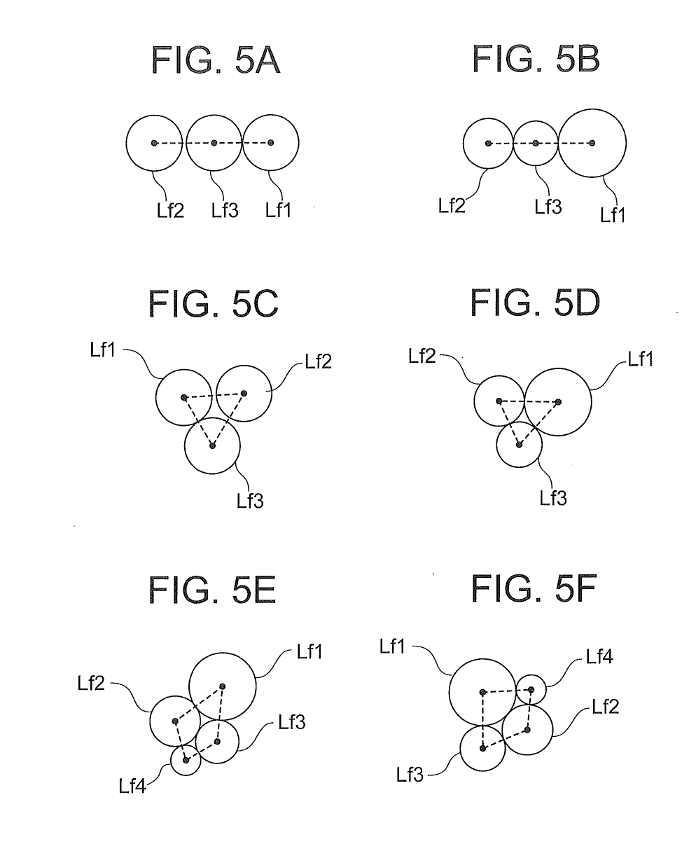

Moreover, it is desirable that an arrangement is such that, line segments indicated by dashed lines connecting centers of three or more than three optical systems are disposed either on a straight line or on a polygonal shape as shown in FIG. 5A, FIG. 5B, FIG. 5C, FIG. 5D, FIG. 5E, and FIG. 5F.

Furthermore, the image pickup apparatus 100 may be provided with a rotating mechanism which changes positions of the optical systems.

Accordingly, a degree of freedom of selecting optical systems is improved.

Moreover, it is desirable that at least one of the information of the object acquired by the object-information acquiring section 103 is information of distance.

It is possible to achieve an appropriate stereoscopic image by computing the amount of parallax in accordance with the distance of the object.

It is possible to use a prevalent method as a method for acquiring the object distance. It is desirable to acquire the object distance by image processing from images photographed by at least two of the plurality of optical systems, or to acquire information of depth of the object while changing a focusing position (autofocus) by using at least one of the plurality of optical systems, or to acquire by distance map that has been computed, for example.

Moreover, it is desirable that the optical-system selecting section 105 selects optical systems for which, the distance between the optical axes is nearest to the base length at which, a main object from among the objects is displayed with the appropriate amount of parallax. Here, the main object may be set in advance by a photographer, or the image pickup apparatus 100 may include a main-object judging section, which may judge an object at a central position of an image, or an object which is focused perfectly, to be the main object. However, a method for identifying the main object is not restricted to the abovementioned methods.

Accordingly, it is possible to determine the appropriate amount of parallax from the position of the main object.

Generally, for the observer to observe an object comfortably, it is preferable that with respect to the distance A between the screen SC and a position of the eye of the observer, the object is positioned at a position in a range of A/2 before the screen SC to A/2 on an inner side of the screen. Therefore, it is desirable that the optical-system selecting section 105 selects the optical system from the parallax and the base length such that the object is seemed to be positioned in this range.

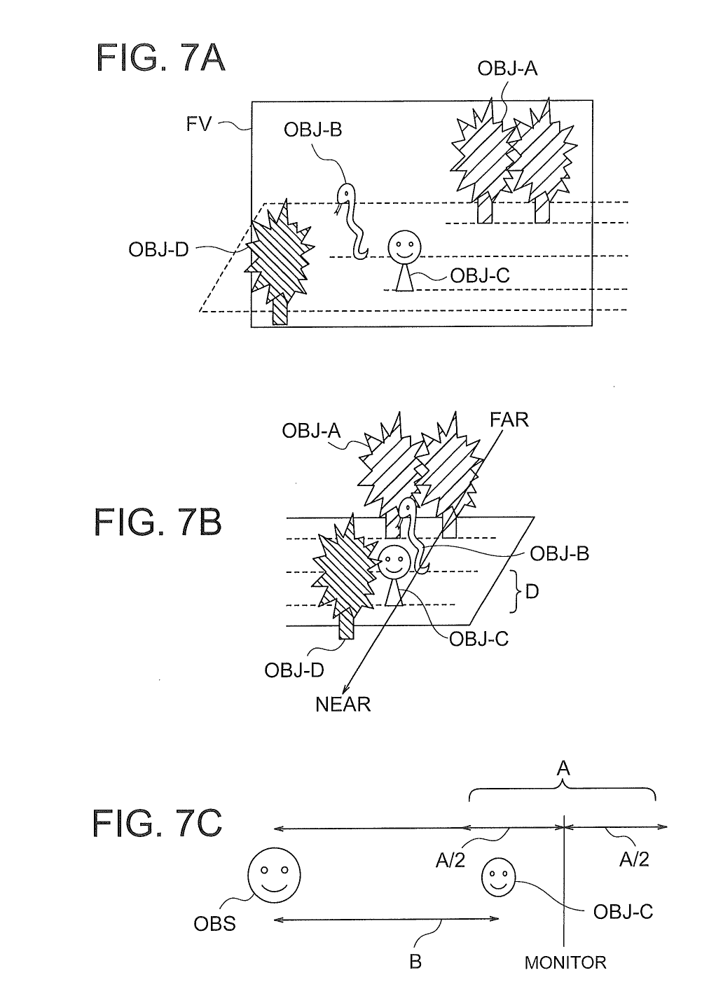

A plurality of objects OBJ-A, OBJ-B, OBJ-C, and OBJ-D will be described below by using FIG. 7A, FIG. 7B, and FIG. 7C. In each diagram, a depth of field in a direction of depth is let to be D. A frontward direction is a direction close to the image pickup apparatus and an inner direction is a direction farther from the image pickup apparatus. Moreover, a photographing range at the time of photography is FV (FIG. 7A).

In a case of making a pop-out display of the main object at a position of the object OBJ-C, the parallax-amount computing section 104 computes the amount of parallax at which the display distance B of the OBJ-C is in a range of A/2 to A, and moreover, the base-length computing section 106 computes the base length corresponding thereto. Finally, the optical-system selecting section 105 selects a pair of optical systems having a distance between the optical axes of the optical systems to be nearest to the base length that has been computed.

Moreover, it is desirable that the optical-system selecting section 105 selects the optical systems having the distance between the optical axes of the optical systems nearest to the base length at which, an object displayed nearest to the image pickup apparatus is displayed with the appropriate amount of parallax.

Accordingly, it is possible to carry out a more appropriate display for the user.

In general, it is desirable that a difference in an angle of convergence of an object displayed most frontward and an object displayed on the screen (amount of parallax 0) is not more than 1°. For this, it is desirable that the optical-system selecting section 105 selects the optical system from the parallax and the base length accommodating in that range.

In this case, the parallax-amount computing section 104 computes the angle of convergence of the object OBJ-D which is the nearest object to the image pickup apparatus 100, and an amount of parallax for which a difference A in the angle of convergence on the monitor becomes 1° or less than 1°. The base-length computing section 106 calculates the base length corresponding thereto. The optical-system selecting section 105 selects a pair of optical systems having the distance between the optical axes nearest to the base length.

For calculating more favorable amount of parallax when the observer is observing, the pop-out appropriate maximum parallax amount x is expressed by the following expression (2).

x=(A−B)×e/B

B=e/2(tan α/2)

α=ATAN(e/(2×A))×2+Δ (2)

where,

e denotes the width of the eyes of the observer,

A denotes the observation distance,

B denotes the appropriate shortest display distance, and

Δ denotes a difference between an angle of convergence α of the nearest object and an angle of convergence β on the monitor.

It is desirable that the optical-system selecting section 105 selects an optical system for which, the parallax of the object with the shortest object distance from among the objects in the depth of field of the optical system is displayed with an appropriate amount of parallax.

Accordingly, it is possible to carry out more appropriate display for the observer. Moreover, objects out of the depth of field being blurred, can be excluded from the targets to be observed.

As aforementioned, it is preferable that the difference in the angle of convergence is not more than 1°. For this, it is desirable that the optical-system selecting section 105 selects the optical system from the parallax and the base length that are within that range.

As shown in FIG. 7A and FIG. 7B, the parallax-amount computing section 104 computes the amount of parallax for which, a difference in the angle of convergence of the object OBJ-C which is the object nearest to the image pickup apparatus 100 in a range of a depth of field D and the angle of convergence on the monitor becomes 1° or less than 1°. The base-length computing section 106 computes the base length corresponding thereto. The optical-system selecting section 105 selects a pair of optical systems having the distance between the optical axes nearest to the base length that has been computed.

The depth of field is expressed by the following expressions (3a) and (3b).

front depth of field Lr=δ×Fno×L²/(f²−δ×Fno×L) (3a)

rear depth of field Lf=δ×Fno×L²/(f²−δ×Fno×L) (3b)

where,

f denotes a focal length (mm),

Fno denotes an F number,

δ denotes a permissible diameter of circle of confusion (mm), and

L denotes a focus object distance (mm)

However, since there are cases which differ from the abovementioned expressions due to factors such as an aberration of an optical system, the definition of the depth of field is not restricted to the abovementioned expression.

Moreover, in the portable terminal 200, in a case in which, the parallax of an object with a long object distance from among the objects in the depth of field of the optical system is not displayed by an appropriate amount of parallax, it is desirable that the image pickup apparatus further includes the blurring processing section 113 which carries out a blurring processing on the object with the long object distance. In this case, it is preferable to make a judgment of whether or not the blurring processing section 113 or other member has been displayed with an appropriate amount of parallax.

Accordingly, it is possible to achieve a more natural stereoscopic image.

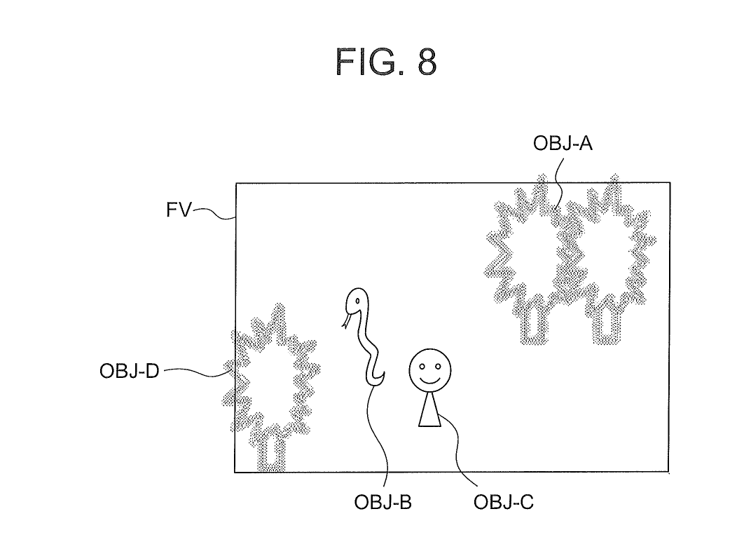

FIG. 8 shows an example in which, the blurring processing section 113 has carried out the blurring processing on the objects OBJ-A and OBJ-D.

Moreover, it is desirable that the portable terminal 200 includes the coordinate converting section 114 which carries out a coordinate conversion of an image in a case in which, a difference between the appropriate amount of parallax and the amount of parallax of a photographic image is not smaller than a predetermined value.

Accordingly, in a case in which, optical systems with the distance between the optical axes in accordance with the base length of the appropriate amount of parallax do not exist, and in a case in which, the optical-system selecting section 105 has selected optical systems having the distance between the optical axes nearest to the base length that has been computed, the coordinate converting section 104 carries out coordinate conversion of an image only by an amount by which the amount of parallax has shifted. As a result, a stereoscopic image with an appropriate parallax is achieved.

When there exists no combination of optical systems having the distance between the optical axes smaller than the appropriate base length, photography is to be carried out with the smallest combination, and coordinate conversion is to be carried out in the post processing.

The coordinate converting section 114 carries out coordinate conversion by shifting an image only by X-X′. More specifically, the coordinate converting section 114 shifts the image to an inner side when a value of X-X′ is positive, and shifts the image to an outer side when the value of X-X′ is negative.

Here, X denotes an appropriate amount on the image pickup element and X′ denotes an amount of parallax of the image acquired by the optical systems selected.

Moreover, it is desirable that focal lengths of all of the three or more than three optical systems in the portable terminal 200 are different.

Accordingly, the observer is capable of photographing an object by changing the photographing range. In other words, by photographing in a photographing range appropriate to the object, it is possible to achieve even more natural stereoscopic image.

By having the plurality of optical systems, it is possible to small-size the image pickup apparatus 100, and to carry out 2D (two-dimensional) photography with each optical system singly. Moreover, the optical-system selecting section 105, by selecting the optical systems, is capable of adjusting the base length. Since it is possible to carry out photography with a wider range at a wide angle, adjustment of the amount of parallax and a position of the screen becomes easy.

Moreover, it is preferable that the portable terminal 200 has an arrangement that includes an optical zooming section which changes an angle of view of an output image output by at least one of the three or more than three optical systems in the mobile terminal 200. Furthermore, it is desirable that a part of the angle of view changed by the optical zooming section is same as the angle of view of the other optical system. In this case, the term ‘same’ also includes ‘substantially same’.

Accordingly, the observer is capable of acquiring an image while verifying a parallax image of the same angle of view.

Moreover, it is desirable that the portable terminal 200 includes the electronic zooming section 115 which changes the angle of view of an output image output by at least one of the three or more than three optical systems in the mobile terminal 200. Furthermore, it is desirable that a part of the angle of view changed by the electronic zooming section is substantially same as an angle of view of the other optical system.

Accordingly, the portable terminal 200 is capable of acquiring an image while verifying the parallax image of the same angle of view. Furthermore, since there is no movement of lens due to optical zooming, small-sizing is facilitated. Moreover, since it is possible to simplify the mechanism, and at the same time, there exists no movable portion, it is possible to prevent generation of noise. Furthermore, a movement of an image is smooth.

Moreover, it is desirable that the photographing range of the three or more than three optical systems in the mobile terminal 200 includes the photographing range of at least one other optical system.

Accordingly, the coordinate converting section 114, by carrying out coordinate conversion of an image, is capable of preventing the image from becoming small in a case in which, the parallax correction has been carried out.

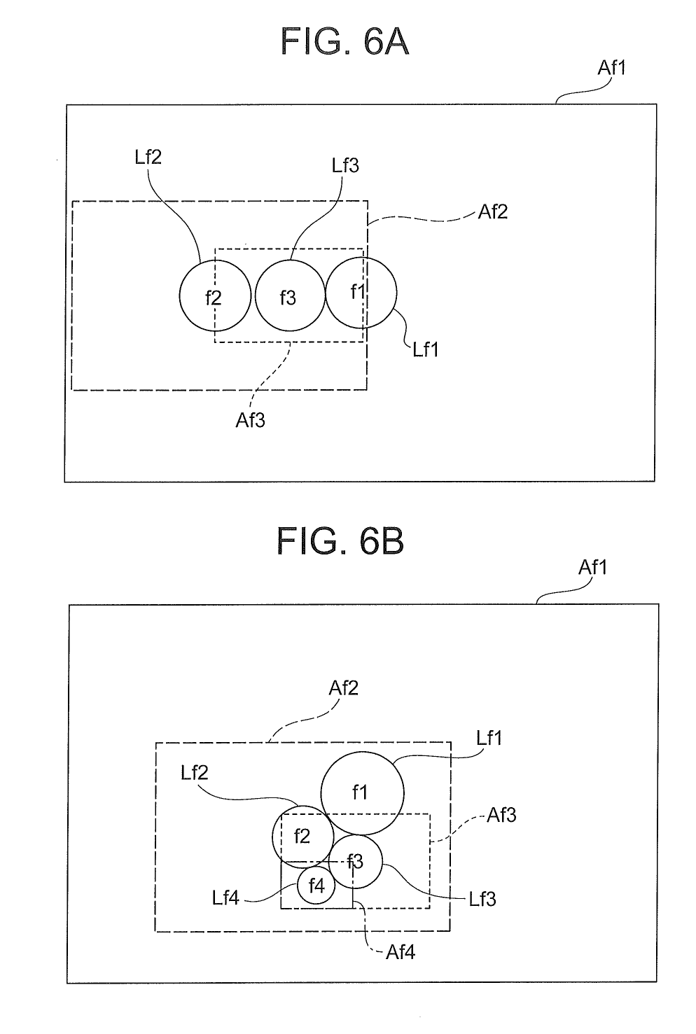

FIG. 6A shows photographing ranges Af1, Af2, and Af3 of the optical systems Lf1, Lf2, and Lf3 respectively of the mobile terminal 200.

FIG. 6B shows photographing ranges Af1, Af2, Af3, and Af4 of the four optical systems Lf1, Lf2, Lf3, and Lf4.

Moreover, it is desirable that the optical-system selecting section 105 selects an optical system with an optical system with the smallest angle of view as a reference, in the optical systems in the mobile terminal 200.

By conforming to an image with the narrowest photographing range, it is possible to suppress to be small, a change in an image when the parallax correction by the coordinate conversion is carried out.

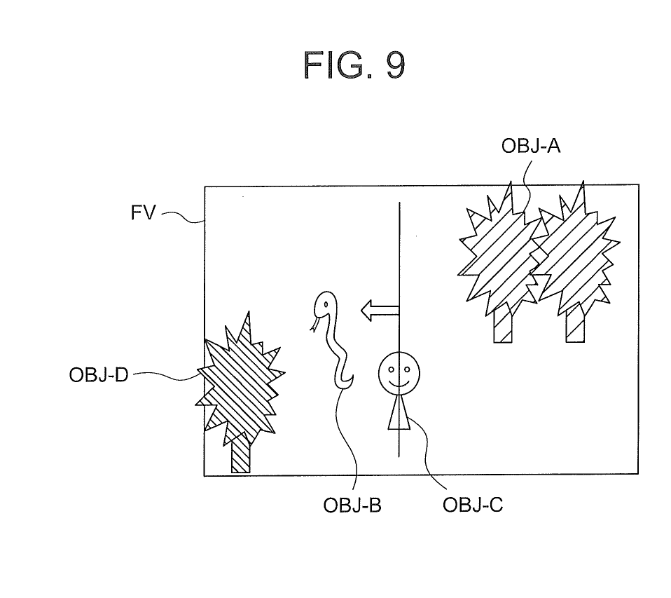

Moreover, in a case in which, the coordinate conversion becomes necessary, it is desirable that the portable terminal 200 includes a guide display section (an arrow mark shown in FIG. 9) which indicates diagrammatically, keeping in a field of view, a position of the object at which, an amount of coordinate conversion is reduced.

Accordingly, in the optical system that has been selected, photography at a position at which, a position of the object of an image with a narrow field of view assumes a predetermined amount of parallax. Accordingly, it is possible to suppress to be small, the change in the image when the parallax correction by coordinate conversion is carried out.

### Second Embodiment

An image pickup method according to a second embodiment of the present invention includes,

an object-information acquiring step of acquiring information of an object,

a parallax-amount computing step of computing an amount of parallax corresponding to the information of the object, and

an optical-system selecting step of selecting an optical system for photographing, from among not less than three optical systems, based on the amount of parallax corresponding to the information of the object, which has been computed.

Accordingly, it is possible to achieve an appropriate stereoscopic image.

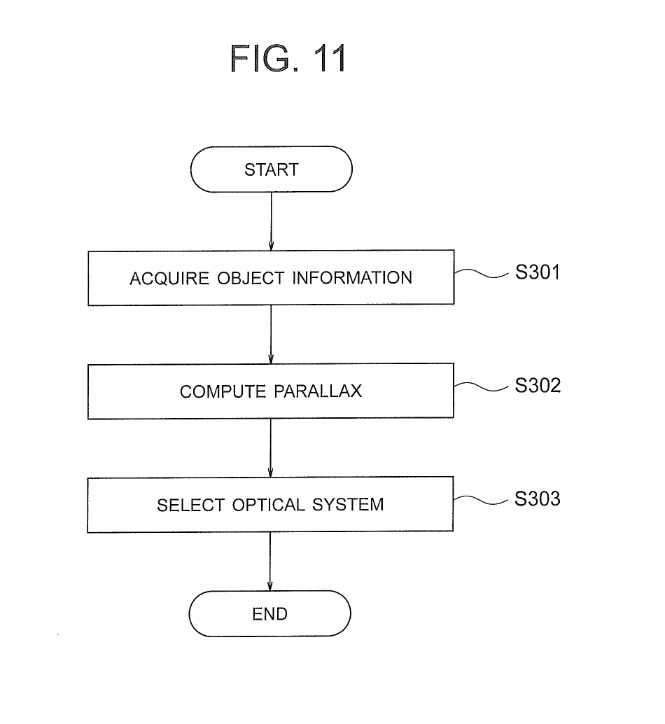

FIG. 11 is a flowchart showing basic image pickup procedure according to the present embodiment. At step S301, the object-information acquiring section 103 acquires information of an object. At step S302, the parallax-amount computing section 104 computes the amount of parallax corresponding to the information of the object. At step S303, the optical-system selecting section 105 selects optical systems for photographing from among three or more than three optical systems, based on the amount of parallax corresponding to the information of the object which has been computed by the parallax-amount computing section 104.

Accordingly, a movement of the optical system is unnecessary, and it is possible to achieve an appropriate stereoscopic image.

### First Modified Example

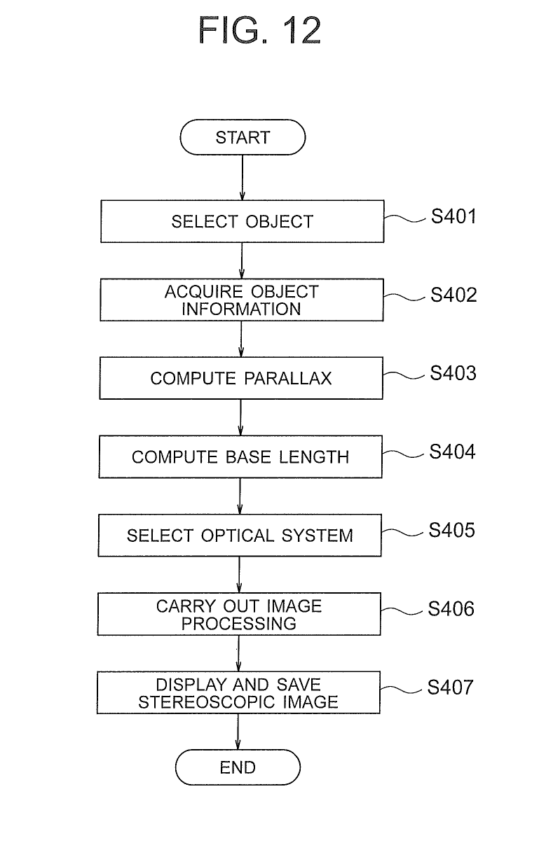

FIG. 12 is a flowchart showing a detailed procedure according to a modified example of the present embodiment.

At step S401, a photographer selects an object.

At step S402, the object-information acquiring section 103 acquires information of the object.

At step S403, the parallax-amount computing section 104 computes an amount of parallax corresponding to the information of the object.

At step S404, the base-length computing section 106 computes the base length based on the information of the object obtained from the object-information acquiring section 103 and the amount of parallax computed by the parallax-amount computing section 104.

At step S405, the optical-system selecting section 105 selects an optical system for photographing from among the three or more than three optical systems based on the amount of parallax corresponding to the information of the object computed by the parallax-amount computing section 104.

At step S406, the blurring processing section 113 carries out the blurring processing, and the coordinate conversion section 114 carries out the coordinate conversion of the image.

At step S407, the display section 109 and the monitor 110 displays a stereoscopic image. Moreover, the memory 111 saves image data.

### Second Modified Embodiment

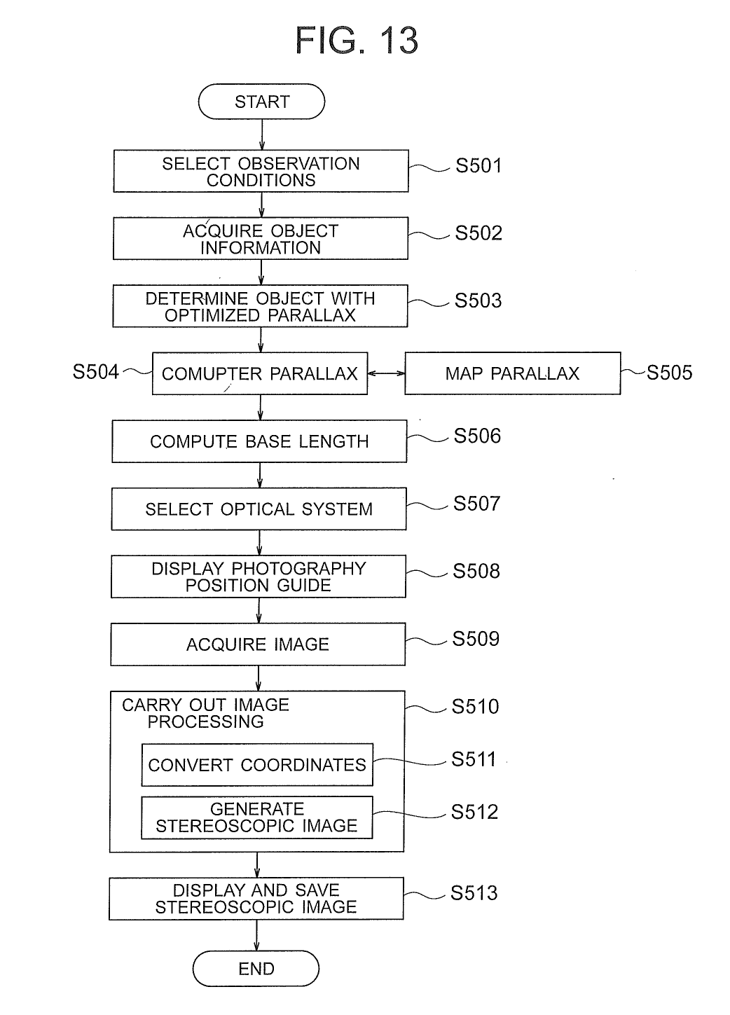

FIG. 13 is a flowchart showing a more detailed procedure according to another modified example of the present invention.

At step S501, a photographer inputs observation conditions such as a smart phone, a television, and a screen.

At step S502, the object-information acquiring section 103 acquires information of an object.

At step S503, an object for which, an amount of parallax is to be optimized, is determined.

At step S504, the parallax-amount computing section 104 computes the amount of parallax corresponding to the information of the object. At this time, at step S505, a parallax map may be referred to.

At step S506, the base-length computing section 106 computes the base length based on the information of the object obtained from the object-information acquiring section 103 and the amount of parallax computed by the parallax-amount computing section 104.

At step S507, the optical-system selecting section 105 selects an optical system for photographing from among the three or more than three optical systems, based on the amount of parallax corresponding to the information of the object that has been computed by the parallax-amount computing section 104.

At step S508, a photographing position guide such as an arrow mark is displayed according to the requirement.

At steps S509, S510, S511, and S512, the image processing and image generating section 108 carries out the coordinate conversion mentioned in the first embodiment, and generation of a stereoscopic image.

At step S513, the display section 109 and the monitor 110 display the stereoscopic image. Moreover, the memory 111 saves image data.

### Third Embodiment

Next, an image pickup apparatus according to a third embodiment of the present invention will be described below. In the following description, same reference numerals are assigned to components which are same as in the embodiments described heretofore. Moreover, description already made in the embodiments will be omitted to avoid repetitive description.

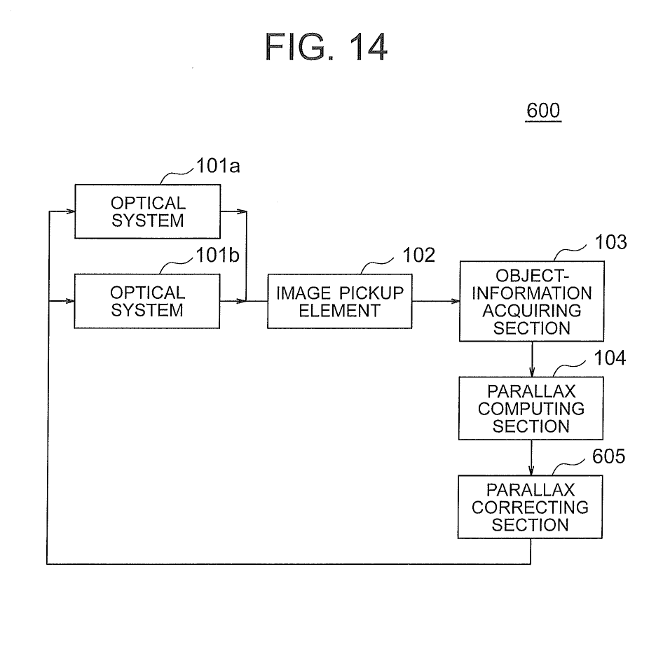

FIG. 14 is a basic functional block diagram of an image pickup apparatus 600 according to the present embodiment.

The image pickup apparatus 600 includes not less than two optical systems 101a and 101b, and the image pickup element 102. Furthermore, the image pickup apparatus 600 includes the object-information acquiring section 103, the parallax-amount computing section 104, and the parallax correcting section 605.

The object-information acquiring section 103 acquires information of an object. The parallax-amount computing section 104 computes the amount of parallax corresponding to the information of the object. The parallax correcting section 605 corrects the amount of parallax based on information from an optical system for photographing that is selected from among not less than two optical systems 101a and 101b.

A detailed procedure for correcting the amount of parallax will be described later.

Accordingly, the image pickup apparatus 600 according to the present embodiment is capable of acquiring an image with an appropriate amount of parallax without moving the optical system.

The amount of parallax computed by the parallax-amount computing section 104 is determined from photographing conditions and observation conditions. Selection of the photographing conditions and the observation conditions may be carried out automatically or manually.

For instance, as a photographing condition, it is possible to select photographing by a multifunction cellular telephone (hereinafter, called as a ‘smart phone’) as has already been mentioned, and as an observation condition, it is possible to select observing by a smart phone or observing by another display.

Here, the amount of parallax may be computed from the information of the object that has been acquired, for any of an object at a nearest position or an object at a farthest position with reference to a focusing distance (distance from the image pickup apparatus up to the focusing position).

Furthermore, the parallax-amount computing section 104 is also capable of computing the amount of parallax by using a parallax map (parallax table) in which, observation conditions possessed in advance are reflected. In this case, the image pickup apparatus 600 may be equipped with a memory which is not shown in the diagram, and the memory may have the parallax map recorded therein.

The image pickup element 102 may have an arrangement of one-to-one in which, one image pickup element is provided for one optical system, or an arrangement in which, one image pickup element is provided for a plurality of optical systems.

Furthermore, it is possible to carry out small-sizing with a plurality of optical systems not less than two, and 2-D photographing with each optical system singly.

Since it is possible to carry out photography with even wider range at a wide angle side, adjustment of the amount of parallax and screen position also becomes easy.

A front view, a rear view, and a side view of a portable terminal which is an example of the image pickup apparatus 600 being same as FIG. 2A, FIG. 2B, and FIG. 2C respectively, description thereof is omitted.

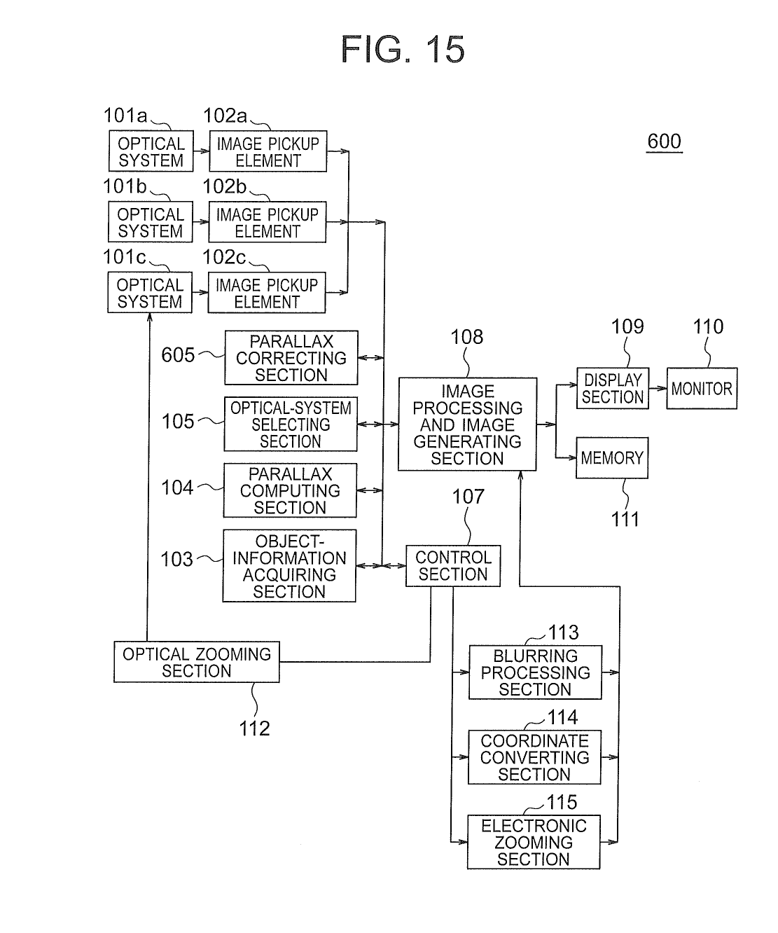

Next, an arrangement will be explained in detail by using FIG. 15. Here, FIG. 14 shows an indispensable arrangement of the present embodiment, and FIG. 15 shows even more desirable arrangement.

More than two optical systems, here, three optical systems 101a, 101b, and 101c, are disposed in the present embodiment.

Moreover, it is desirable that a photographing range of any one of the optical systems 101a, 101b, and 101c includes a photographing range of at least one other optical system.

Accordingly, it is possible to prevent an image from becoming small even in the parallax that has been corrected.

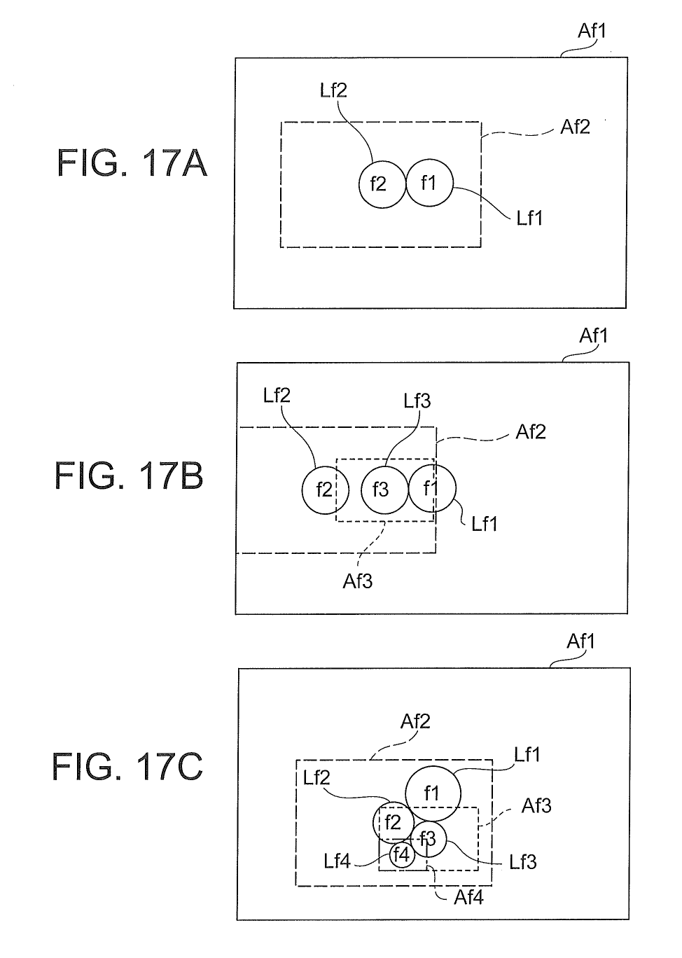

FIG. 17A shows the photographing ranges Af1 and Af2 of the two optical systems Lf1 and Lf2 respectively.

FIG. 17B shows the photographing ranges Af1, Af2, and Af3 of the three optical systems Lf1, Lf2, and Lf3 respectively.

FIG. 17C shows the photographing ranges Af1, Af2, Af3, and Af4 of the four optical systems Lf1, Lf2, Lf3, and Lf4 respectively.

The portable terminal 200 includes in addition to the image pickup apparatus 600, the parallax-correcting section 605, the optical-system selecting section 105, the control section 107, the image processing and image generating section 108, the display section 109, the monitor 110, the memory 111, the optical zooming section 112, the blurring processing section 113, the coordinate converting section 114, and the electronic zooming section 115. In FIG. 15, the image pickup element 102 includes the image pickup elements 102a, 102b, and 102c. However, the image pickup element 102 may include one image pickup element.

The object-information acquiring section 103 acquires information of an object. The parallax-amount computing section 104 computes a range of an appropriate amount of parallax from a position of the object. The optical-system selecting section 105 selects not less than two optical systems based on the amount of parallax, or the base length that has been computed from the amount of parallax and the information of the object obtained from the object-information acquiring section 103. The parallax-correcting section 605 corrects the amount of parallax based on information from the optical system for photographing that has been selected by the optical-system selecting section 105.

The image processing and image generating section 108 generates an image that has been subjected to blurring processing and coordinate conversion that will be described later. The memory 111 stores image data generated by the image processing and image generating section 108. The display section 109 displays the image generated by the image processing and image generating section 108. The monitor 110 display the image generated by the image processing and image generating section 108.

Here, regarding the object distance, the amount of parallax, and the base length, calculation method is same as the abovementioned calculation method described by referring to FIG. 10.

### (Example of Calculation of Base Length)

In a case of observing an object using the 4.3 inch smart phone (HD display), the observation distance is let to be 250 mm and the width of eyes is let to be 65 mm. A position of the shortest stereoscopic image that can be observed appropriately is at 234 mm from the eyes of the observer, and the amount of parallax at that time becomes 4.44 mm.

Whereas, in a case of photographing by using a camera of a smart phone, when the number of pixels is HD and the pixel pitch is 2 μm for instance, the amount of parallax becomes 0.18 mm (90 pixels) on the image pickup element.

In a case in which, the parallax on the image pickup element from an image being photographed is 200 pixels, the correction of parallax is carried out by shifting the image only by an amount equivalent to 110 pixels.

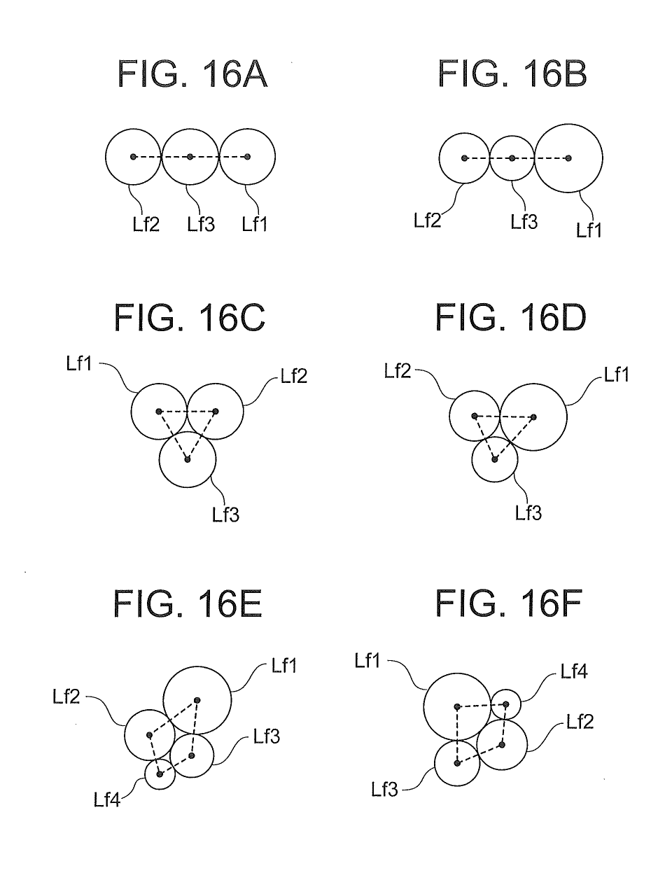

Here, a variation in arrangement of the plurality of optical systems not less than two will be described below. FIG. 16A, FIG. 16B, FIG. 160, FIG. 16D, FIG. 16E, and FIG. 16F are diagrams when an arrangement of three or four optical systems Lf1, Lf2, Lf3, and Lf4 is seen from a front.

It is desirable that a photographing range of the optical system with the smallest angle of view is included in a photographing range of the other optical system.

Accordingly, by conforming to an image with the narrowest photographing range, it is possible to suppress to be small, a change in an image when the parallax correction is carried out.

It is desirable that an arrangement is such that, line segments indicated by dashed lines connecting centers of two or more than two optical systems are disposed either on a straight line or on a polygonal shape as shown in FIG. 16A, FIG. 16B, FIG. 16C, FIG. 16D, FIG. 16E, and FIG. 16F.

Moreover, the image pickup apparatus 600, as it will be described later, may be provided with a rotating mechanism which changes positions of the optical systems.

Furthermore, an arrangement may be any of an arrangement in which, distances between centers of the plurality of optical systems not less than two are same or an arrangement in which, distances between centers of the plurality of optical systems not less than two are all different.

Accordingly, it is possible to have a state in which, the photographing range is included in the other photographing range.

It is desirable that the parallax correcting section 605 carries out correction of parallax based on information of a position of the object that has been acquired by the object-information acquiring section 103.

Accordingly, it is possible to achieve an appropriate stereoscopic image conforming to the information of the object.

Moreover, it is desirable that at least one of the information of the object acquired by the object-information acquiring section 103 is information of distance.

Accordingly, it is possible to achieve an appropriate stereoscopic image conforming to the distance of the object.

As a method of acquiring the object distance, a prevalent method can be used. It is desirable to carry out ranging from imaged photographed by at least two of the plurality of optical systems, or to acquire information of depth of an object while changing a focusing position by using at least one of the plurality of optical systems (autofocus), or to acquire from a distance map that has been computed.

It is desirable that the parallax correcting section 605 corrects the parallax based on the amount of parallax corresponding to the information of the object that has been computed by the parallax-amount computing section 104.

Accordingly, it is possible to correct to an appropriate parallax appropriate to the object.

Furthermore, it is preferable that the parallax correcting section 605 corrects the amount of parallax such that a main object from among the objects is displayed with an appropriate amount of parallax.

Accordingly, it is possible to achieve a stereoscopic image in which, the main object has an appropriate amount of parallax.

As aforementioned, a range which enables comfortable observation in general, with respect to the distance A between the screen SC and a position of the eye, is considered to be in a range from A/2 before to A/2 on an inner side of the screen. Therefore it is desirable to select the optical system from the parallax and the base length such that the object is in this range.

A plurality of objects OBJ-A, OBJ-B, OBJ-C, and OBJ-D will be described below by referring to FIG. 7A and FIG. 7B used in the description of the first embodiment. In each diagram, a depth of field in a direction of depth is let to be D. A frontward direction is a direction close to the image pickup apparatus, and an inner direction is a direction farther from the image pickup apparatus. Moreover, a photographing range at the time of photography is FV (FIG. 7A).

In a case of making a pop-out display of the main object at the main object OBJ-C, the parallax-amount computing section 104 computes the amount of parallax at which the display distance of the OBJ-C becomes in a range from A/2 to A, and moreover, the optical-system selecting section 105 selects a pair of optical systems based on the amount of parallax or the base length corresponding to the amount of parallax.

It is desirable that the parallax correcting section 605 corrects the amount of parallax such that the object which is displayed nearest to the image pickup apparatus is displayed with an appropriate amount of parallax.

Accordingly, in a pop-out which exerts significant strain on eyes, it is possible to carry out a display at a position which is suitable for the eyes.

As described in the first embodiment, generally, a difference of not more than 1° in an angle of convergence of an object displayed most frontward and an object displayed on the screen (amount of parallax 0) is considered to be appropriate. For this, it is desirable to select the optical systems from the parallax and the base length accommodating in that range.

In this case, the parallax-amount computing section 104 computes the angle of convergence of the object OBJ-D which is the most frontward object, and an amount of parallax for which a difference in the angle of convergence on the monitor becomes 1° or less than 1°. The optical-system selecting section 105 selects a pair of optical systems based on the amount of parallax or the base length corresponding to the amount of parallax.

For calculating more favorable amount of parallax when the observer is observing, the pop-out appropriate maximum parallax amount x is expressed by the aforementioned expression (2).

It is desirable that the parallax correcting section 605 corrects the amount of parallax such that a parallax of the object with the shortest object distance from among the objects in the depth of field of the optical system is displayed with an appropriate amount of parallax.

Accordingly, in a pop-out which exerts significant strain on eyes, it is possible to carry out a display at a position which is suitable for the eyes.

Here, the main object may be set in advance by a photographer, or the image pickup apparatus 600 may include a main-object judging section, which may judge an object at a central position of an image, or an object which is focused perfectly, to be the main object. However, a method for identifying the main object is not restricted to the abovementioned methods.

Furthermore, objects of the depth of field being blurred can be excluded from the targets to be observed.

An amount of parallax for which, a difference in an angle of convergence of the most frontward object in a range of depth of field, or in other words, the object OBJ-C, and an angle of convergence on the monitor is not more than 1° is to be calculated.

The depth of field is calculated by the aforementioned expressions (3a) and (3b).

As shown in FIG. 7A and FIG. 7B, the parallax amount computing section 104 computes the amount of parallax for which, the difference in the angle of convergence of the object OBJ-C which is the most frontward object in the range of the depth of field D and the angle of convergence on the monitor becomes 1° or less than 1°. The optical-system selecting section 105 selects a pair of optical systems based on the amount of parallax or the base length corresponding to the amount of parallax.

It is desirable that the parallax correcting section 605 corrects the amount of parallax in a case in which, a difference between the amount of parallax corresponding to the object position computed by the parallax-amount computing section 104 and the appropriate amount of parallax is not smaller than a predetermined value.

Accordingly, it is possible to correct to an appropriate amount of parallax.

It is preferable that the parallax correcting section 605 includes the coordinate converting section 114 which carries out coordinate conversion of an image.

Accordingly, in a case in which, optical systems with the distance between the optical axes in conformity with the base length of the appropriate amount of parallax do not exist, and in a case in which, the optical-system selecting section 105 has selected optical systems having the distance between the optical axes nearest to the base length that has been computed, the coordinate converting section 104 carries out coordinate conversion of an image only by an amount by which the amount of parallax has shifted.

When there exists no combination of optical systems having the distance between the optical axes smaller than the appropriate base length, photography is to be carried out with the smallest combination, and coordinate conversion is to be carried out in the post processing.

The coordinate conversion is to be carried out by a procedure for shifting an image only by X-X′.

It is desirable that the portable terminal 200 includes the blurring processing section 113 which carries out blurring processing on the object with the long object distance in a case in which, a parallax of the object for which the object distance is long from among the objects in the depth of field of the optical system is not displayed by an appropriate parallax.

Accordingly, it is possible to prevent the inability to observe comfortably due to the strain exerted on eyes due to a parallax of more than a predetermined value, and it is possible to achieve a natural stereoscopic image.

If the amount of parallax is not less than the width of eyes, movement of a left eye and a right eye is in outward direction, and stereoscopic image cannot be observed.

An example in which, the blurring processing is carried out on the objects OBJ-A and OBJ-D is same as the aforementioned case described by using FIG. 8.

It is desirable that the portable terminal 200 includes the optical-system selecting section 105 which selects not less than two optical systems from among two or more than two optical systems, and photographs a parallax image.

Accordingly, the parallax image is photographed by two or more than two optical systems. At this time, the optical-system selecting section 105 selects optical systems according to an angle of view to be photographed, a parallax correction amount, and the base length.

The portable terminal 200 includes the optical zooming section 112 which changes the angle of view of an output image that is output by at least one of the two or more than two optical systems.

It is desirable that a part of the angle of view to be changed by the optical zooming section 112 is substantially same as the angle of view of the other optical system.

Accordingly, it is possible to acquire an image while verifying a parallax image with the same angle of view.

It is desirable that the portable terminal 200 includes the electronic zooming section 115 which changes the angle of view of an output image that is output by at least one of two or more than two optical systems, and that a part of the angle of view to be changed by the electronic zooming section 115 is substantially same as the angle of view of the other optical system.

Accordingly, it is possible acquire an image while verifying a parallax image with the same angle of view.

As heretofore mentioned, the zooming may be by any of the methods namely, an optical zooming and an electronic zooming. In a case of the electronic zooming, there is no movement of lenses compared to the movement of lenses in the optical zooming. Therefore, the electronic zooming has advantages such as small-sizing of the apparatus is possible, it is possible to simplify the mechanism, there is no drive noise, and the movement is smooth.

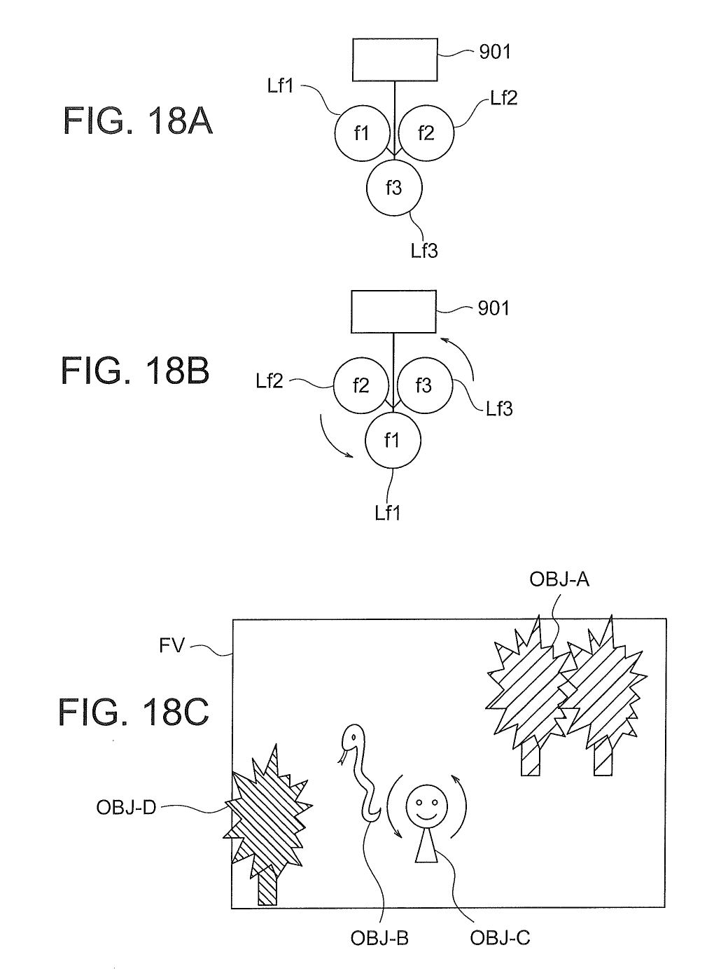

Furthermore, it is desirable that the portable terminal 200 according to the present embodiment includes an optical-system rotating mechanism 901 as shown in FIG. 18A and FIG. 18B.

The optical-system rotating mechanism 901 rotates optical systems such that the arrangement of the optical systems (Lf1, Lf2, and Lf3) selected by the optical-system selecting section 105 becomes appropriate for the image pickup element, and carries out photography.

Accordingly, a parallax image which can be displayed by an appropriate format is acquired.

Moreover, at the time of displaying a normal stereoscopic image, it is necessary to generate parallax images that can be displayed in an appropriate format such as a side-by-side format in which, the parallax images are displayed side-by-side.

For instance, in a case in which, an optical system that has been selected is inclined, the optical-system rotating mechanism 901 rotates the optical system that has been selected such that, the optical system is positioned to be in mutually horizontal direction with respect to the observer, and carries out photography.

Moreover, it is desirable that the portable terminal 200 includes the image processing and image generating section 108 which carries out image processing such that the image becomes an appropriate parallax image on the image pickup element, according to the arrangement of the optical systems selected by the optical-system selecting section 105.

Accordingly, it is possible to acquire a parallax image which can be displayed in an appropriate format.

Moreover, it is desirable that the portable terminal 200 includes the guide display section (an arrow mark shown in FIG. 18C) which displays a photography guide such that an image becomes an appropriate parallax image on the image pickup element, according to the arrangement of the optical systems selected by the optical-system selecting section 105.

Accordingly, it is possible to acquire a parallax image which can be displayed in an appropriate format.

As aforementioned, at the time of displaying a normal stereoscopic image, it is necessary to generate parallax images that can be displayed in an appropriate format such as the side-by-side format, in which the parallax images are displayed side-by-side.

For instance, in the portable terminal 200, it is desirable to show diagrammatically a direction of rotation and an amount of rotation in the field of view FV by a numerical value or an arrow, with an arrow of a length and thickness corresponding to the amount of rotation and the photographing range after the rotation, as shown in FIG. 18C.

### Fourth Embodiment

Next, a fourth embodiment of the present invention will be described below.

An image pickup method according to the fourth embodiment includes,

an object-information acquiring step of acquiring information of an object,

a parallax-amount computing step of computing an amount of parallax corresponding to the information of the object, and

a parallax correcting step of correcting the amount of parallax based on information from two or more than two optical systems having different focal lengths.

Accordingly, it is possible to achieve an appropriate stereoscopic image all the time.

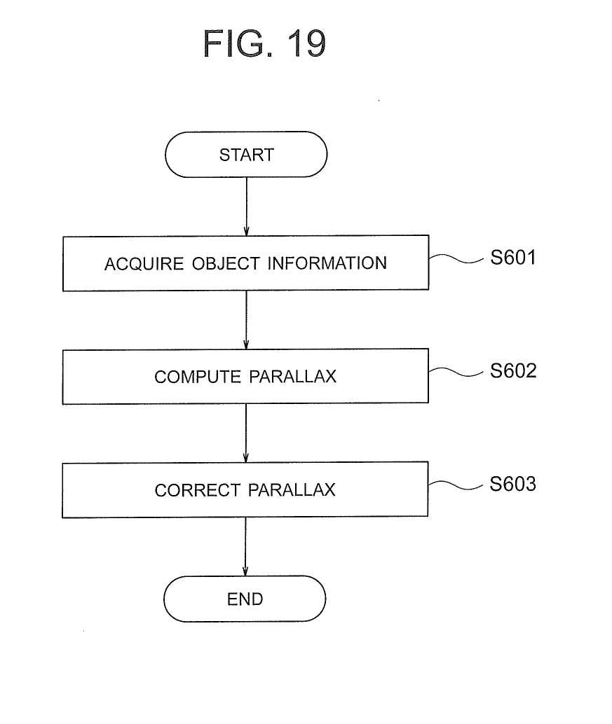

FIG. 19 is a flowchart showing a basic image pickup procedure according to the present embodiment. At step S601, the object-information acquiring section 103 acquires information of an object. At step S602, the parallax-amount computing section 104 computes an amount of parallax corresponding to the information of the object. At step S603, the parallax correcting section 605 corrects the amount of parallax based on information from two or more than two optical systems having different focal lengths.

Accordingly, a movement of the optical system is unnecessary, and it is possible to achieve an appropriate stereoscopic image.

### First Modified Example

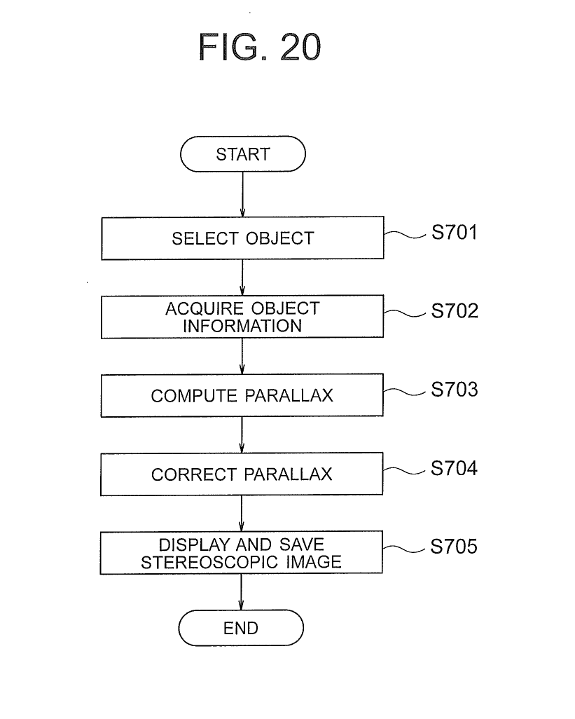

FIG. 20 is a flowchart showing a detailed procedure according to a modified example of the present embodiment.

At step S701, a photographer selects an object.

At step S702, the object-information acquiring section 103 acquires information of the object. At step S703, the parallax-amount computing section 104 computes an amount of parallax corresponding to the information of the object.

At step S704, the parallax correcting section 605 corrects the amount of parallax based on information from the two or more than two optical systems having different focal lengths.

At step S705, the display section 109 and the monitor 110 display a stereoscopic image. Moreover, the memory 111 saves image data.

### Second Modified Example

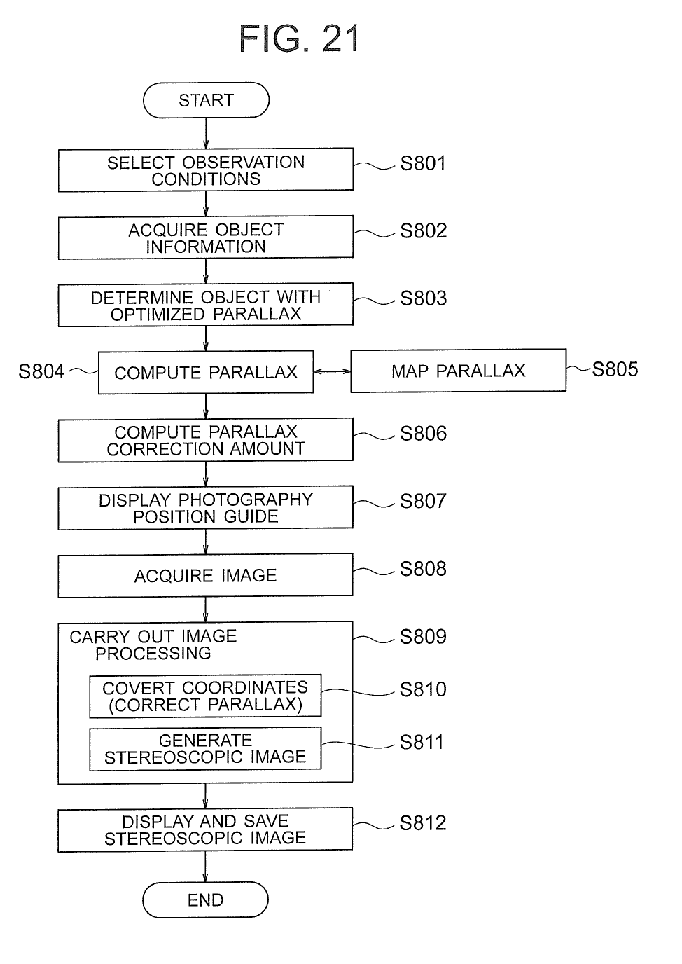

FIG. 21 is a flowchart showing a further detailed procedure according to another modified example of the present embodiment.

At step S801, a photographer inputs observation conditions such as a smart phone, a telephone, and a screen.

At step S802, the object-information acquiring section 103 acquires information of an object.

At step S803, an object for which, an amount of parallax is to be optimized, is determined.

At step S804 the parallax-amount computing section 104 computes the amount of parallax corresponding to the information of the object. At this time, at step S805, a parallax map may be referred to.

At step S806, the parallax correcting section 605 corrects the amount of parallax based on the amount of parallax that has been computed.

At step S807, a photographing position guide such as an arrow mark is displayed according to the requirement.

At steps S808, S809, S810, and S811, the image processing and image generating section 108 carries out coordinate conversion mentioned in the third embodiment, and generation of a stereoscopic image.

At step S812, the display section 109 and the monitor 110 display the stereoscopic image. Moreover, the memory 111 saves image data.

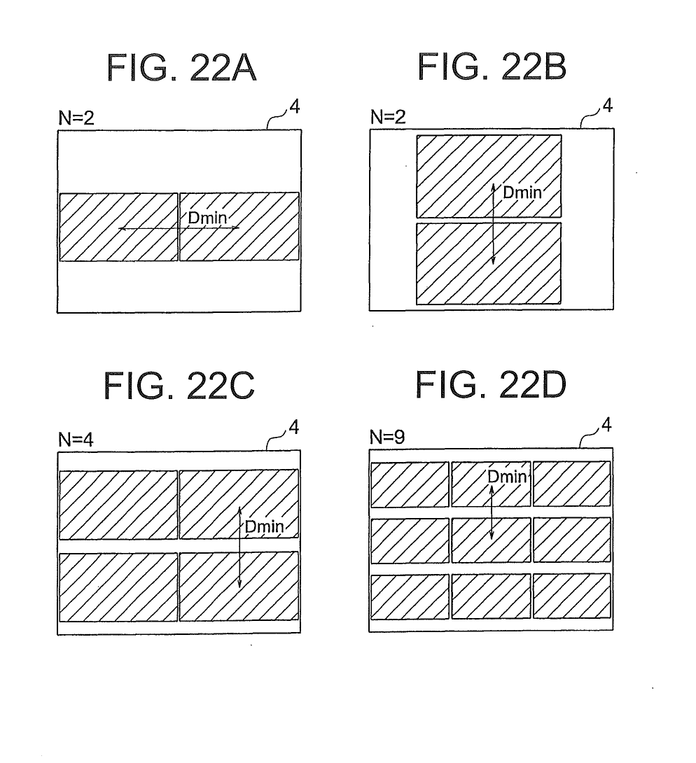

Aspects of the embodiments will be described below. FIG. 22A, FIG. 22B, FIG. 22C, and FIG. 22D are diagrams showing division of an image pickup surface of an image pickup element 4. A plurality of zoom lenses is disposed to form an image of an object in different areas of the image pickup surface of the same image pickup element. FIG. 22A, FIG. 22B, FIG. 22C, and FIG. 22D show arrangements viewed from front of the image pickup surface of the image pickup element 4. In each diagram, N indicates the number of zoom lenses, or in other words, the number of modules.

For example two rectangular areas (shown with oblique lines) in the image pickup element 4 shown in FIG. 22A show areas for forming images of an object by respective zoom lenses when the zoom lenses are arranged side-by-side in a horizontal direction. The shortest distance between centers of the two image forming areas is indicated by Dmin.

Here, an aspect ratio of the image pickup element 4 is illustrated to be 4:3, and image pickup areas of the zoom lenses are illustrated to be 16:9.

FIG. 22B shows image forming areas in the image pickup element 4 when the two zoom lenses (N=2) are arranged to be up and down in a vertical direction.

FIG. 22C shows image forming areas in the image pickup element 4 when a total of four zoom lenses (N=4) arranged such that two pairs of zoom lenses each arranged side-by-side in the horizontal direction, are arranged up and down in the vertical direction.

Furthermore, FIG. 22D shows image forming areas in the image pickup apparatus 4 when a total of nine zoom lenses (N=9) are arranged such that, three rows of three zoom lenses each arranged side-by-side, are arranged in the vertical direction.

An action and effect of providing the plurality of zoom lenses, not less than three, will be described below.

By using the plurality of zoom lenses, not less than three, a 3-D image pickup independent of a direction of an image pickup system becomes possible. When the two zoom lenses are arranged side-by-side only in a leftward-rightward direction (horizontal direction) for example, in a case in which, a digital camera is used in a direction of a portrait position, the plurality of zoom lenses is to be arranged one below the other in the longitudinal position (vertical direction). In image pickup in this case, a parallax image in the leftward-rightward direction is not achieved.

Whereas, when four or more than four zoom lenses are arranged in the vertical direction and the leftward-rightward direction, in a case in which, the image pickup system is let to be in the portrait position and in a case in which, the image pickup system is let to be in a landscape position, it is possible to acquire a parallax image in the leftward-rightward direction in both the cases. Moreover, even in a state between the portrait position and the landscape position, it is possible to interpolate a natural stereoscopic image from vertical and leftward-rightward parallax images.

Moreover, in a case of arranging three zoom lenses side-by-side in the horizontal direction (lateral direction), it is possible to acquire parallax images in a multiple view. Accordingly, a degree of freedom of stereoscopic-image viewing such as a 3-D viewing by a plurality of people, and movement of a viewer is improved.

If the number of zoom lenses is increased gradually to realize these, with the increase in the number of zoom lenses, a variation due to a cause such as a manufacturing error becomes significant. For this reason, an importance of an arrangement of reducing a variation, such as an arrangement of holding lenses by a common member, which is a peculiarity of the present arrangement, increases.

According to the image pickup apparatus of the present embodiment, by disposing at least two zoom lenses having same focal-length range, it is possible to achieve a plurality of parallax images of which, an angle of view is easily variable. Therefore, a degree of freedom of 3-D photographing scenes is improved.

Moreover, in two arbitrary zoom lenses from among the plurality of zoom lenses, a distance between the optical axes from a surface of incidence up to an image pickup surface is substantially equal. Accordingly, by a parallel method in which, the optical axes of the zoom lenses are parallel, and by a cross method in which, optical axes of variable power optical systems cross at a great distance, it is possible to acquire parallax information close to information that is achieved by two human eyes.

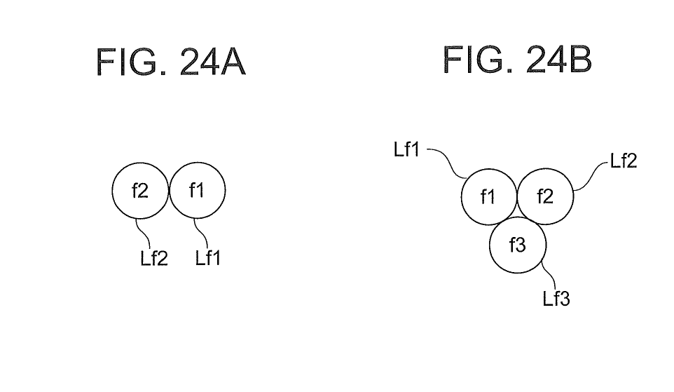

Next, various basic values when focal lengths of the plurality of optical systems differ will be shown. FIG. 24A is a diagram when such an optical system is viewed from a front. A lens Lf1 having a fixed focal point f1 and a lens Lf2 having a fixed focal point f2 are disposed to be arranged side-by-side in a lateral direction with respect to a single image pickup element.

### Numerical Example 1

Lens having a fixed focal length
Unit mm
Surface data

| Surface no. | r | d | nd | νd |
|---|---|---|---|---|
| Object plane | ∞ | ∞ | | |
| 1 | 17.092 | 0.69 | 1.92286 | 20.88 |
| 2 | 11.685 | 2.09 | 1.74320 | 49.34 |
| 3* | 207.393 | 0.32 | | |
| 4 | 164.069 | 0.63 | 1.88300 | 40.76 |
| 5 | 6.908 | 1.81 | | |
| 6 | −12.196 | 0.63 | 1.78800 | 47.37 |
| 7 | 5.313 | 1.67 | 1.84666 | 23.78 |
| 8 | 40.510 | 9.37 | | |
| 9(stop) | ∞ | 0.63 | | |
| 10* | 14.023 | 1.17 | 1.58313 | 59.38 |
| 11 | −20.051 | 10.26 | | |
| 12* | 15.871 | 2.89 | 1.49700 | 81.54 |
| 13 | −5.848 | 0.63 | 1.88300 | 40.76 |
| 14 | −8.692 | 0.63 | | |
| 15 | −38.291 | 0.63 | 1.92286 | 20.88 |
| 16 | 12.287 | 5.37 | | |
| 17 | ∞ | 0.00 | | |
| 18 | 37.408 | 2.03 | 1.75211 | 25.05 |
| 19 | −18.946 | 15.62 | | |
| 20 | ∞ | 1.13 | 1.51633 | 64.14 |
| 21 | ∞ | 1.18 | | |
| Image plane | ∞ | | | |
| (Image pickup | | | | |
| surface) | | | | |

Aspherical surface data
3rd surface
K = 0.000
A4 = 6.71509e−06
10th surface
K = −8.887
A4 = 2.54220e−04, A6 = −5.63250e−06
12th surface
K = 0.000
A4 = −1.78527e−04, A6 = 1.25518e−06,
A8 = 7.99258e−08

| | |
|---|---|
| Focal length | 8.76 |
| FNO. | 4.98 |
| Angle of view 2ω | 70.52 |
| Image height | 5.40 |
| fb (in air) | 17.55 |
| Lens total length (in air) | 59.01 |

Unit focal length
Gf1 = 28.12 Gf2 = −4.60 Gf3 = 14.33 Gf4 = 15.20 Gf5 = −10.02
Gf6 = 16.98

Fixed focal length f2
Unit mm
Surface data

| Surface no. | r | d | nd | νd |
|---|---|---|---|---|
| Object plane | ∞ | ∞ | | |
| 1 | 17.092 | 0.69 | 1.92286 | 20.88 |
| 2 | 11.685 | 2.09 | 1.74320 | 49.34 |
| 3* | 207.393 | 14.43 | | |
| 4 | 164.069 | 0.63 | 1.88300 | 40.76 |
| 5 | 6.908 | 1.81 | | |
| 6 | −12.196 | 0.63 | 1.78800 | 47.37 |
| 7 | 5.313 | 1.67 | 1.84666 | 23.78 |
| 8 | 40.510 | 0.53 | | |
| 9(stop) | ∞ | 0.63 | | |
| 10* | 14.023 | 1.17 | 1.58313 | 59.38 |
| 11 | −20.051 | 0.32 | | |
| 12* | 15.871 | 2.89 | 1.49700 | 81.54 |
| 13 | −5.848 | 0.63 | 1.88300 | 40.76 |
| 14 | −8.692 | 8.57 | | |
| 15 | −38.291 | 0.63 | 1.92286 | 20.88 |
| 16 | 12.287 | 2.11 | | |
| 17 | ∞ | 0.00 | | |
| 18 | 37.408 | 2.03 | 1.75211 | 25.05 |
| 19 | −18.946 | 15.62 | | |
| 20 | ∞ | 1.13 | 1.51633 | 64.14 |
| 21 | ∞ | 1.18 | | |
| Image plane | ∞ | | | |
| (Image pickup | | | | |
| surface) | | | | |

Aspherical surface data
3rd surface
K = 0.000
A4 = 6.71509e−06
10th surface
K = −8.887
A4 = 2.54220e−04, A6 = −5.63250e−06
12th surface
K = 0.000
A4 = −1.78527e−04, A6 = 1.25518e−06,
A8 = 7.99258e−08

| | |
|---|---|
| Focal length | 59.59 |
| FNO. | 6.34 |
| Angle of view 2ω | 10.09 |
| Image height | 5.40 |
| fb (in air) | 17.55 |
| Lens total length (in air) | 59.01 |

Unit focal length
Gf1 = 28.12 Gf2 = −4.60 Gf3 = 14.33 Gf4 = 15.20 Gf5 = −10.02
Gf6 = 16.98

Next, a numerical example of an optical system with an arrangement having three zooming optical systems will be shown below. For example, the arrangement is such that the optical system includes three zooming optical systems Lf1, Lf2, and Lf3 as shown in FIG. 24B. Here, an image can be picked up by letting f1 to be a wide angle end, f2 to be an intermediate, and f3 to be a telephoto end.

Zoom lens
Unit mm
Surface data

| Surface no. | r | d | nd | νd |
|---|---|---|---|---|
| Object plane | ∞ | ∞ | | |
| 1 | 17.092 | 0.69 | 1.92286 | 20.88 |
| 2 | 11.685 | 2.09 | 1.74320 | 49.34 |
| 3* | 207.393 | variable | | |
| 4 | 164.069 | 0.63 | 1.88300 | 40.76 |
| 5 | 6.908 | 1.81 | | |
| 6 | −12.196 | 0.63 | 1.78800 | 47.37 |
| 7 | 5.313 | 1.67 | 1.84666 | 23.78 |
| 8 | 40.510 | variable | | |
| 9(stop) | ∞ | 0.63 | | |
| 10* | 14.023 | 1.17 | 1.58313 | 59.38 |
| 11 | −20.051 | variable | | |
| 12* | 15.871 | 2.89 | 1.49700 | 81.54 |
| 13 | −5.848 | 0.63 | 1.88300 | 40.76 |
| 14 | −8.692 | variable | | |
| 15 | −38.291 | 0.63 | 1.92286 | 20.88 |
| 16 | 12.287 | variable | | |
| 17 | ∞ | 0.00 | | |
| 18 | 37.408 | 2.03 | 1.75211 | 25.05 |
| 19 | −18.946 | 15.62 | | |
| 20 | ∞ | 1.13 | 1.51633 | 64.14 |
| 21 | ∞ | 1.18 | | |
| Image plane | ∞ | | | |
| (Image pickup | | | | |
| surface) | | | | |

Aspherical surface data
3rd surface
K = 0.000
A4 = 6.71509e−06
10th surface
K = −8.887
A4 = 2.54220e−04, A6 = −5.63250e−06
12th surface
K = 0.000
A4 = −1.78527e−04, A6 = 1.25518e−06,
A8 = 7.99258e−08

Zoom data
Zoom ratio 6.8

| | Wide angle end | intermediate | telephoto end |
|---|---|---|---|
| Focal length | 8.76 | 22.49 | 59.59 |
| FNO. | 4.98 | 5.59 | 6.34 |
| Angle of view 2ω | 70.52 | 26.89 | 10.09 |
| Image height | 5.40 | 5.40 | 5.40 |
| fb (in air) | 17.55 | 17.55 | 17.55 |
| Lens total length | 59.01 | 59.01 | 59.01 |
| (in air) | | | |
| d3 | 0.32 | 7.17 | 14.43 |
| d8 | 9.37 | 3.03 | 0.53 |
| d11 | 10.26 | 5.35 | 0.32 |
| d14 | 0.63 | 6.82 | 8.57 |
| d16 | 5.37 | 3.58 | 2.11 |

Unit focal length
Gf1 = 28.12 Gf2 = −4.60 Gf3 = 14.33 Gf4 = 15.20 Gf5 = −10.02
Gf6 = 16.98

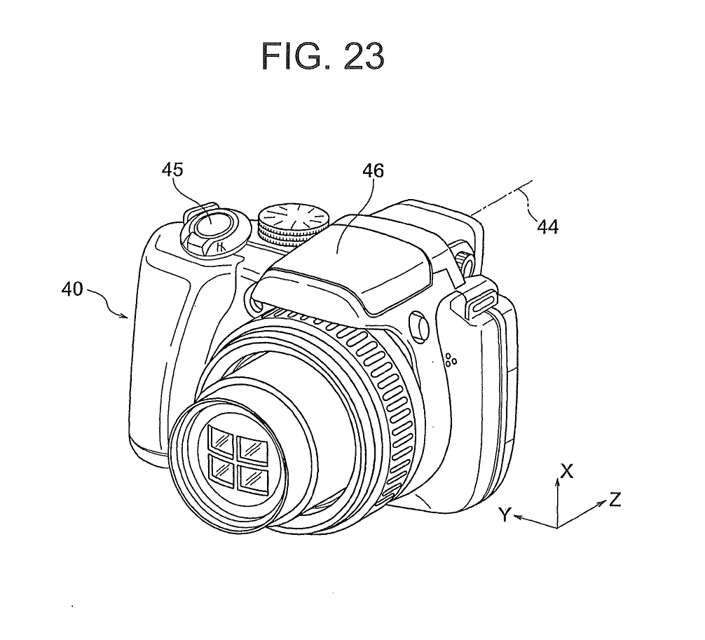

FIG. 23 is a front perspective view showing an appearance of a digital camera 40.

The digital camera 40 in a case of this example includes a photographing optical system 41 positioned above an optical path for photography 42, a finder optical system 43 positioned above an optical path for finder, a shutter button 45, a pop-up stroboscope 46, and a liquid-crystal display monitor. As the shutter button 45 disposed on an upper portion of the camera 40 is pressed, in conjunction with the pressing of the shutter button 45, photography is carried out by a photographing optical system, such as a lens of the abovementioned numerical example.

The present embodiment can have various modified examples without departing from the scope of the invention.

In such manner, the present invention is suitable for an image pickup apparatus and an image pickup method in which, a small-sized and appropriate stereoscopic image is achieved.

The present invention shows an effect that it is possible to provide an image pickup apparatus and an image pickup method in which, a small-sized and appropriate stereoscopic image is achieved.

1. An image pickup apparatus which includes not less than three optical systems, and an image pickup element which picks up an object image by the optical system, comprising:
an object-information acquiring section which acquires information of an object;
a parallax-amount computing section which computes an amount of parallax corresponding to the information of the object; and
an optical-system selecting section which selects optical systems for photographing from among not less than three optical systems, based on the amount of parallax corresponding to the information of the object, that has been computed by the parallax-amount computing section.

2. The image pickup apparatus according to claim 1, further comprising:
a base-length computing section which computes a base length based on the information of the object that has been obtained from the object-information acquiring section, and the amount of parallax that has been computed by the parallax-amount computing section, wherein
the three or more than three optical systems are disposed such that, distances between optical axes of the optical systems are different, and
the optical-system selecting section selects optical systems having the distance between the optical axes nearest to the base length that has been computed.

3. The image pickup apparatus according to one of claims 1 and 2, wherein an arrangement is at least one of an arrangement in which, line segments which connect centers of the three or more than three optical systems are disposed on a straight line, and an arrangement in which, the line segments which connect the centers of the three or more than three optical systems are disposed to be in a polygonal shape.

4. The image pickup apparatus according to claim 1, wherein at least one of the information of the object acquired by the object-information acquiring section is information of distance.

5. The image pickup apparatus according to claim 1, wherein the optical-system selecting section selects optical systems for which, the distance between the optical axes is nearest to the base length at which, a main object from among the objects is displayed with the appropriate amount of parallax.

6. The image pickup apparatus according to claim 1, wherein the optical-system selecting section selects optical systems for which, the distance between the optical axes is nearest to the base length at which, an object displayed nearest to the image pickup apparatus is displayed with the appropriate amount of parallax.

7. The image pickup apparatus according to claim 1, wherein the optical-system selecting section selects an optical system for which, a parallax of the object with the shortest object distance from among the objects in a depth of field of the optical system, is displayed with an appropriate amount of parallax.

8. The image pickup apparatus according to claim 1, further comprising:
a blurring processing section which carries out a blurring processing on an object with a long object distance, in a case in which, a parallax of the object with the long object distance from among the objects in a depth of field of the optical system, is not displayed with an appropriate amount of parallax.

9. The image pickup apparatus according to claim 1, comprising:
a coordinate converting section which carries out coordinate conversion of an image in a case in which, a difference in an appropriate amount of parallax and an amount of parallax of a photographic image is not less than a predetermined value.

10. The image pickup apparatus according to claim 1, wherein focal lengths of all the three or more than three optical systems are different.

11. The image pickup apparatus according to claim 1, comprising:
an optical zooming section which changes an angle of view of an output image that has been output by at least one of the three or more than three optical systems, wherein
a part of the angle of view that is changed by the optical zooming section is substantially same as an angle of view of the other optical system.

12. The image pickup apparatus according to claim 1, comprising:
an electronic zooming section which changes an angle of view of an output image that has been output by at least one of the three or more than three optical systems, wherein
a part of the angle of view that is changed by electronic zooming section is substantially same as an angle of view of the other optical system.

13. The image pickup apparatus according to claim 11, wherein a photographing range of the three or more than three optical systems includes a photographing range of at least one of the other optical systems.

14. The image pickup apparatus according to claim 11, wherein the optical-system selecting section selects the optical systems with reference to an optical system with the smallest angle of view.

15. The image pickup apparatus according to claim 1, comprising:
a guide display section which, in a case in which, a coordinate conversion becomes necessary, indicates diagrammatically by keeping in a field of view, a position of the object for which, an amount of coordinate conversion in reduced.

16. An image pickup method comprising:
an object-information acquiring step of acquiring information of an object;
a parallax-amount computing step of computing an amount of parallax corresponding to the information of the object; and
an optical-system selecting step of selecting optical systems for photographing, from among not less than three optical systems, based on the amount of parallax corresponding to the information of the object, that has been computed.

17-37. (canceled)

38. The image pickup apparatus according to claim 1, comprising:
a parallax correcting section which corrects the amount of parallax.
